(19) United States
(12) Patent Application Publication
(10) Pub. No.: US 2026/0009507 A1
(43) Pub. Date: Jan. 8, 2026

(54) GAS DELIVERY SYSTEM FOR A PRESSURIZED GAS CYLINDER AND A QUICK LOCKING ASSEMBLY THEREOF

(71) Applicant: GHOTRA INNOVATIONS INC., Langley (CA)

(72) Inventor: Surinderpal Singh GHOTRA, Langley (CA)

(73) Assignee: GHOTRA INNOVATIONS INC., Langley (CA)

(21) Appl. No.: 19/335,879

(22) Filed: Sep. 22, 2025

Related U.S. Application Data
(63) Continuation of application No. PCT/CA2024/050790, filed on Jun. 12, 2024.
(60) Provisional application No. 63/472,375, filed on Jun. 12, 2023.

(51) Int. Cl. F17C 13/04; G05D 16/00

(52) U.S. Cl. CPC F17C 13/04; G05D 16/028; F17C 2201/0109; F17C 2201/058; F17C 2203/0617; F17C 2205/0115; F17C 2205/0165; F17C 2205/0305; F17C 2205/0338; F17C 2205/037; F17C 2205/0394; F17C 2221/012; F17C 2223/0123

(57) ABSTRACT

There is provided a gas cylinder assembly for connecting a gas cylinder to a fuel cell. The gas cylinder assembly includes a first pressure regulator including an inlet port connectable to the gas cylinder and an outlet port. The first pressure regulator is configured to reduce pressure passing therethrough by a first factor. The gas cylinder assembly includes a second pressure regulator including an inlet port and an outlet port connectable to the fuel cell. The second pressure regulator is configured to reduce pressure passing therethrough by a second factor which is less than the first factor. The gas cylinder assembly includes a quick locking assembly via which the outlet port of the first pressure regulator and the inlet port of the second pressure regulator are selectively connectable.

### BACKGROUND OF THE INVENTION

### Field of the Invention

There is provided a gas delivery system. In particular, there is provided a gas delivery system for a pressurized gas cylinder including a quick locking assembly thereof.

### Description of the Related Art

U.S. Pat. No. 6,851,447 to Carroll discloses a direct acting pressure regulator. The regulator controls the flow of a gas from a high pressure source to a low pressure device. Gas is delivered from the regulator at a predetermined outlet pressure. The regulator includes a body having a high pressure inlet and defining a seat. A bonnet is engageable with the body to define a piston chamber within the body and the bonnet. The bonnet has a regulated gas outlet. A piston is disposed within the piston chamber and defines a gap between the piston and a wall defining the chamber. The piston is movable between an open regulator condition and a closed regulator condition. The piston includes a plug having a sealing surface engageable with the seat and movable toward the seat to the closed regulator condition and away from the seat to the open regulator condition. The plug includes axially disposed openings therein for communicating gas from around the plug to a central longitudinal bore in the piston. The piston has an impingement surface in flow communication with the central bore such that gas pressure on the impingement surface exerts a force on the piston to move the piston to the closed regulator condition. A spring urges the piston to the open regulator condition.

United States Patent Application Publication No. 2002/0056477 A1 to Pin discloses a fluid pressure reduction system formed from at least a first module and a second module. The modules cooperate with each other in order to ensure at least expansion of the fluid and are able to be connected to and/or disconnected from each other. The connection of the modules is provided by connection elements with a rotary ring carried by the first module and/or the second module. Such a system may be fitted to any fluid line, especially a medical gas line.

U.S. Pat. No. 6,095,572 to Ford et al. discloses a quarter turn quick connect fitting assembly for connecting miniature fluid conduits, such as tubing. The assembly includes a first fitting having radially projecting pins and a second fitting located within a rotatable quarter turn nut having spiral grooves which receive the pins. The first fitting defines a central passage and the second fitting defines a central passage which may each be configured to slidably receive a hollow tube set, or to threadably receive an externally threaded mating fitting. The quarter turn quick connect fitting can be configured to attach to the end of a column, and can include an adapter, which houses a guard column, or a frit for filtering the fluid passing through the quarter turn quick connect fitting assembly. The quarter turn quick connect fitting is assembled by sliding the pins of the first fitting into the grooves of the quarter turn nut and rotating the quarter turn nut through approximately 90° with respect to the first fitting, thereby securely seating the pins within angled areas defined at the ends of the grooves.

United Kingdom Patent Application Publication No. 919230 to Snowman discloses a releasable coupling for liquefied gas conduits. The releasable coupling includes complementary tubular half-coupling members carried by the ends of respective gas conduits, and formed to be releasably engaged with each other, to provide a continuous liquid-carrying bore through the assembled coupling. At least one sleeve member surrounds and is slidably mounted upon one of the half-coupling members. A restricted bleed passage is provided through the wall of the latter for discharging gas into the clearance space between the sleeve member and the half-coupling member so as to purge the clearance space of moisture-bearing air and prevent icing up of the sleeve member.

U.S. Pat. No. 5,087,086 to Snedeker discloses a coupling. The coupling has first and second tube portions joined by a control collar that is rotatable to axially position the first and second tube portions in an installed position, a locked position and in a blow-off position. In the locked position, the tube portions are axially inserted and rotated and locked together by a biasing spring against separation and an O-ring member on one tube portion seals against the other tube portion to seal the tube portions together to prevent fluid leakage therefrom when in their locked position. The other tube portion includes a relief port which is opened for safety blow-off of pressure when the one tube portion is positioned in the blow-off position.

United Kingdom Patent Application Publication No. 2552988 to Holbeche et al. discloses a connecting device comprising a piercing housing for receiving a neck of a gas cylinder. The gas cylinder has a top surface comprising a gas outlet. The piercing housing comprises an opening, side walls and a bottom wall, which is vertical to the axis of the gas cylinder. A piercing element is arranged in the piercing housing for piercing the gas outlet of the gas cylinder. A container surrounding the gas cylinder for holding it in position is characterized in that the cross-section of the piercing housing has a non-round shape and the cross-section of the neck of the gas cylinder is shaped accordingly to be able to insert into the piercing housing.

The above-described prior art may suffer a number of disadvantages.

### BRIEF SUMMARY OF INVENTION

There is provided, and it is an object to provide, an improved gas delivery system for a pressurized gas cylinder, including a quick locking assembly thereof, disclosed herein.

There is provided a quick locking assembly for a gas cylinder according to one aspect. The assembly includes a first coupling member. The first coupling member has a primary bore shaped to receive a valve therewithin. The first coupling member includes one or more protrusions extending radially-inwards within the primary bore thereof. The assembly includes a second coupling member shaped to selectively fit within the primary bore of the first coupling member. The second coupling member includes a first female portion shaped to couple with the valve. The second coupling member includes one or more second female portions shaped to receive the one or more protrusions of the first coupling member therewithin. Each said second female portion of the second coupling member is arcuate-shaped at least in part.

There is also provided a quick locking assembly for a gas cylinder according to another aspect. The quick locking assembly includes a first coupling member having a primary bore. The quick locking assembly includes one or more protrusions coupled to the first coupling member. The one or more protrusions extend radially inwards into the primary bore at least in part. The quick locking assembly includes a second coupling member. The second coupling member has an exterior and one or more grooves extending along the exterior thereof. The one or more protrusions are shaped to extend at least in part within and move along a pathway defined by the one or more grooves to enable mating of the second coupling member with the first coupling member. The one or more protrusions so positioned within the one or more grooves are configured to inhibit decoupling the second coupling member from the first coupling member.

There is further provided a quick locking assembly for a gas cylinder according to a further aspect. The quick locking assembly includes a first coupling member having a primary bore. The quick locking assembly includes a second coupling member. The second coupling member is shaped to be received at least in part within the primary bore of the first coupling member. The quick locking assembly includes one or more protrusions coupled to the first coupling member. The one or more protrusions extend radially inwards at least in part into the primary bore of the first coupling member. The one or more protrusions are shaped to engage the second coupling member so received within the first coupling member. The extent to which the one or more protrusions extend radially inwards is selectively adjustable.

There is additionally provided a quick locking assembly for a gas cylinder according to yet another aspect. The quick locking assembly includes a first coupling member having a primary bore. The quick locking assembly includes a second coupling member. The second coupling member is shaped to be received at least in part within the primary bore of the first coupling member. The quick locking assembly includes one or more protrusions coupled to the first coupling member. The one or more protrusions extends radially inwards at least in part into the primary bore of the first coupling member. The one or more protrusions are shaped to engage the second coupling member so received within the first coupling member. The one or more protrusions are substantially enclosed by the first coupling member.

There is also provided a quick locking assembly for a gas cylinder according to yet a further aspect. The quick locking assembly includes a first coupling member having a primary bore. The quick locking assembly includes a second coupling member. The second coupling member is shaped to be received at least in part within the primary bore of the first coupling member. The quick locking assembly includes one or more protrusions coupled to the first coupling member. The one or more protrusions extend radially inwards at least in part into the primary bore of the first coupling member. The one or more protrusions are shaped to engage the second coupling member so received within the first coupling member. The one or more protrusions are radially inwardly spaced from an outer surface of the first coupling member.

There is further provided a quick locking assembly for a gas cylinder according to an additional aspect. The quick locking assembly includes a first coupling member. The first coupling member has a primary bore shaped to receive a valve therewithin. The first coupling member includes one or more protrusions extending radially-inwards within the primary bore thereof. The quick locking assembly includes a second coupling member. The second coupling member is shaped to selectively fit within the primary bore of the first coupling member. The second coupling member includes a first female portion shaped to couple with the valve. The second coupling member includes one or more second female portions. Each said second female portion has an outwardly flared opening or recessed portion shaped to receive the one or more protrusions of the first coupling member therewithin.

There is also provided a quick locking assembly for a gas cylinder according to yet an additional aspect. The quick locking assembly includes a first coupling member. The first coupling member has a primary bore shaped to receive a valve therewithin. The first coupling member includes one or more protrusions. The one or more protrusions extend radially-inwards within the primary bore of the first coupling member. The quick locking assembly includes a second coupling member. The second coupling member is shaped to selectively fit within the primary bore of the first coupling member. The second coupling member includes a first female portion shaped to couple with the valve. The second coupling member includes one or more second female portions. The one or more second female portions of the second coupling member are shaped to receive the one or more protrusions of the first coupling member therewithin. Each of the second female portions of the second coupling member is arcuate-shaped at least in part.

There is further provided a quick locking assembly for a gas cylinder according to another aspect. The quick locking assembly includes a first male member. The first male member is longitudinally-extending and in fluid communication with the gas cylinder. The quick locking assembly includes one or more second male members. Each said second male member is operatively connected to and extends perpendicular to the first male member. The quick locking assembly includes a first female member. The first female member is shaped to mate with the first male member. The quick locking assembly includes one or more second female members. Each said second female member is shaped to receive a corresponding said second male member. The one or more second female members are radially spaced from the first female member.

There is additionally provided a female coupling member configured to couple to a pressure regulator of a gas cylinder according to one aspect. The female coupling member is substantially cylindrical in outer shape. The female coupling member has first and second ends and an outer surface extending between the ends thereof. The female coupling member has a bore extending from the first end towards the second end thereof. The bore of the female coupling member is shaped to receive therein a distal end portion of the pressure regulator. The female member has one or more pathways extending radially inwards from the outer surface thereof. The one or more pathways extend from the first end towards the second end of the female member. Each pathway has an enlarged recessed portion shaped to receive a corresponding locking member or plunger operatively coupled to the pressure regulator.

There is also provided a female coupling member configured to couple to a pressure regulator of a gas cylinder according to another aspect. The female coupling member is substantially cylindrical in outer shape. The female coupling member has first and second ends and an outer surface extending between the ends thereof. The female coupling member has a bore extending from the first end towards the second end thereof. The bore of the female coupling member is shaped to receive therein a distal end portion of the pressure regulator. The female coupling member has one or more pathways extending radially inwards from the outer surface thereof. The one or more pathways extend from the first end towards the second end thereof of the female coupling member. Each pathway is shaped to receive a corresponding locking member or plunger operatively coupled to the pressure regulator. Each pathway is arcuate-shaped at least in part.

There is additionally provided an apparatus for selectively coupling a gas cylinder to a gas delivery system according to one aspect. The apparatus includes a male member. The male member includes a valve with a first end portion thereof connectable to the gas cylinder. The apparatus includes a female member connectable to the gas delivery system. The female member is shaped to receive a second end portion of the valve. The female member includes at least one path. The apparatus includes a housing shaped to receive the gas cylinder therewithin. The housing includes at least one protrusion. The at least one protrusion is shaped to extend within and along the at least one pathway when the female member receives the male member to connect the gas cylinder to the gas delivery system.

There is also provided a gas cylinder assembly for connecting a gas cylinder to a fuel cell according to one aspect. The gas cylinder assembly includes a first pressure regulator including an inlet port connectable to the gas cylinder and includes an outlet port. The first pressure regulator is configured to reduce pressure passing therethrough by a first factor. The gas cylinder assembly includes a second pressure regulator including an inlet port and an outlet port connectable to the fuel cell. The second pressure regulator is configured to reduce pressure passing therethrough by a second factor which is less than the first factor. The gas cylinder assembly includes a quick locking assembly via which the outlet port of the first pressure regulator and the inlet port of the second pressure regulator are selectively connectable.

There is also provided a gas cylinder assembly according to another aspect. The assembly includes a housing having an interior shaped to receive a gas cylinder therewithin. The housing includes a first end portion that is closed and a second end portion with a bore extending therethrough. The assembly includes a pressure regulator. The pressure regulator includes a proximal end portion shaped to couple to an outlet of the gas cylinder. The pressure regulator includes a distal end portion shaped to extend through and/or adjacent the bore of the first end portion of the housing. The assembly includes a bonnet configured to operatively couple the distal end portion of the pressure regulator to the second end portion of the housing.

There is further provided a gas cylinder assembly according to a further aspect. The assembly includes a housing having an interior shaped to receive a gas cylinder therewithin. The housing includes a first end portion that is closed and a second end portion with a bore extending therethrough. The assembly includes a pressure regulator. The pressure regulator includes a proximal end portion shaped to couple to an outlet of the gas cylinder and includes a distal end portion spaced-apart from the proximal end portion thereof. The assembly includes a female male adapter. The female male adapter includes a female portion shaped to couple to the distal end portion of the pressure regulator, extend through said bore and abut an interior surface of the housing. The assembly includes a female adapter shaped to couple to a male portion of the female male adapter and abut an exterior surface of the housing opposite the interior surface of the housing.

There is also provided a gas cylinder assembly according to yet another aspect. The assembly includes a housing shaped to receive a gas cylinder therewithin between spaced-apart end portions thereof. The assembly includes a handle operatively connected to the first end portion of the housing. The assembly includes a pressure regulator connectable to the gas cylinder and positioned adjacent the second end portion of the housing. The assembly includes a longitudinally-extending first male member and one or more laterally-inwardly extending second male members operatively connected to the second end portion of the housing. The assembly includes a gas delivery system shaped to mate with the male members so as to operatively connect to the gas cylinder via the pressure regulator upon the housing rotating a predetermined threshold of rotation relative thereto.

There is yet further provided a gas cylinder assembly according to an additional aspect. The assembly includes a pressure regulator with an inlet port, a diaphragm or piston in fluid communication with the inlet port, and a pressure-reducing mechanism. High-pressure hydrogen gas is configured to enter through the inlet port of the pressure regulator and push against the diaphragm or piston. This triggers the pressure-reducing mechanism to control the flow of hydrogen gas and reduce the pressure thereof to a desired level. The pressure regulator is configured to thereafter enable hydrogen gas of reduced pressure to exit from an outlet port thereof.

There is also provided a gas cylinder assembly for connecting a gas cylinder to a fuel cell according to yet an additional aspect. The gas cylinder assembly includes a housing having an interior within which the gas cylinder is selectively receivable, spaced-apart first and second end portions and a longitudinal axis extending between the end portions thereof. The gas cylinder assembly includes a handle operatively connected to the first end portion of the housing. The gas cylinder assembly includes a pressure regulator positioned adjacent the second end portion of the housing and connectable to the gas cylinder. The gas cylinder assembly includes a longitudinally-extending first male member coupled to the pressure regulator. The gas cylinder assembly includes one or more laterally-inwardly extending second male members operatively connected to the second end portion of the housing. The gas cylinder assembly includes a gas delivery system shaped to mate with the male members so as to operatively connect to the gas cylinder the fuel cell via the pressure regulator upon the housing rotating a predetermined threshold of rotation relative thereto. The gas delivery system includes a female coupling member having one or more longitudinally-extending bores shaped to snugly and sealable receive the longitudinally-extending first male member. The female coupling member has one or more spiral pathways along an outer surface thereof. The one or more spiral pathways are shaped to slidably receive the one or more laterally-inwardly extending second male members.

There is further provided a gas cylinder assembly for manually connecting a gas cylinder to a fuel cell according to yet another aspect. The gas cylinder assembly includes a housing with a first end portion, a second end portion with a bore extending therethrough, and a central portion extending between the end portions thereof. At least one of the end portions of the housing is selectively removable from the central portion of the housing to receive the gas cylinder therewithin. The gas cylinder assembly includes a handle operatively connected to the first end portion of the housing. The gas cylinder assembly includes a pressure regulator with a proximal end portion connectable to the gas cylinder and a distal end portion shaped to extend through the bore and operatively connect to the second end portion of the housing. The gas cylinder assembly includes one or more laterally-extending male members operatively connected to the second end portion of the housing and extending inwards in part within the bore. The gas cylinder assembly includes a female coupling member shaped to rotatably engage with the one or more laterally-extending male members. The female coupling member is fully received within the bore of the second end portion of the housing and enables fluid communication via the pressure regulator between the gas cylinder to the fuel cell upon the housing rotating via the handle a predetermined threshold of rotation relative thereto.

There is yet also provided a gas cylinder assembly for manually connecting a gas cylinder to a fuel cell according to another aspect. The gas cylinder assembly includes a housing with a first end portion, a second end portion with a bore extending therethrough, and a central portion extending between the end portions thereof. At least one of the end portions of the housing is selectively removable from the central portion of the housing to receive the gas cylinder therewithin. The gas cylinder assembly includes a handle operatively connected to the first end portion of the housing. The gas cylinder assembly includes a pressure regulator with a proximal end portion connectable to the gas cylinder and a distal end portion shaped to extend through the bore and operatively connect to the second end portion of the housing. The gas cylinder assembly includes one or more laterally-extending male members operatively connected to the second end portion of the housing and extending inwards in part within said bore. The gas cylinder assembly includes a female coupling member shaped to rotatably engage with the one or more laterally-extending male members to enable passage of the female coupling member with said bore. The pressure regulator is actuated to enable fluid communication between the gas cylinder to the fuel cell only upon the female coupling member being fully received within said bore.

There is also provided a connecting mechanism for coupling a pressure regulator of a gas cylinder to a gas delivery system according to one aspect. The connecting mechanism includes an annular flange extending about a bore and having an inner surface and exterior surface. The connecting mechanism includes a female male adapter with a female portion thereof shaped to couple to a distal end portion of the pressure regulator and abut the interior surface of the flange. The connecting mechanism includes a female adapter operatively connectable to the gas delivery system. The female adapter is shaped to couple to a male portion of the female male adapter and abut the exterior surface of the flange.

There is further provided a method for selectively connecting a gas cylinder to a gas delivery system according to one aspect. The method includes connecting a male member to the gas cylinder. The method includes enclosing the gas cylinder within a housing. The housing includes at least one protrusion in fluid communication with the male member. The method includes connecting a female member to the gas delivery system. The female member has at least one pathway extending about an exterior thereof. The at least one pathway is spiral shaped at least in part. The method includes connecting the male member and the female member together. The connecting step includes positioning the least one protrusion to be received at least in part within the at least one pathway and thereafter rotating the housing relative to the female member.

The method may include within the connecting step, configuring the male member to only be actuated to enable fluid communication between the gas cylinder and the gas delivery system upon the male member being fully mated with the female member.

It is emphasized that the invention relates to all combinations of the above features, even if these are recited in different claims.

Further aspects and example embodiments are illustrated in the accompanying drawings and/or described in the following description.

### BRIEF DESCRIPTION OF DRAWINGS

The accompanying drawings illustrate non-limiting example embodiments of the invention:

FIG. 1 is a front, bottom, left side perspective view of a gas cylinder assembly, a gas delivery system and a quick locking assembly configured to operatively connect together the gas cylinder assembly and the gas delivery system, the gas cylinder assembly being shaped to enclose a pressurized gas cylinder therewithin, and the quick locking assembly comprising a first coupling member including a pressure regulator coupled to the pressure gas cylinder and a second coupling member shown in the process of coupling to the first coupling member;

FIG. 2 is a rear, top, left side perspective view thereof;

FIG. 3 is a cross-sectional view taken along lines 3-3 of the gas cylinder assembly, the gas delivery system and the quick locking assembly of FIG. 1;

FIG. 4 is a right side, top perspective view of the gas cylinder assembly and the quick-locking assembly of FIG. 1, with the second coupling member is shown coupled to the first coupling member;

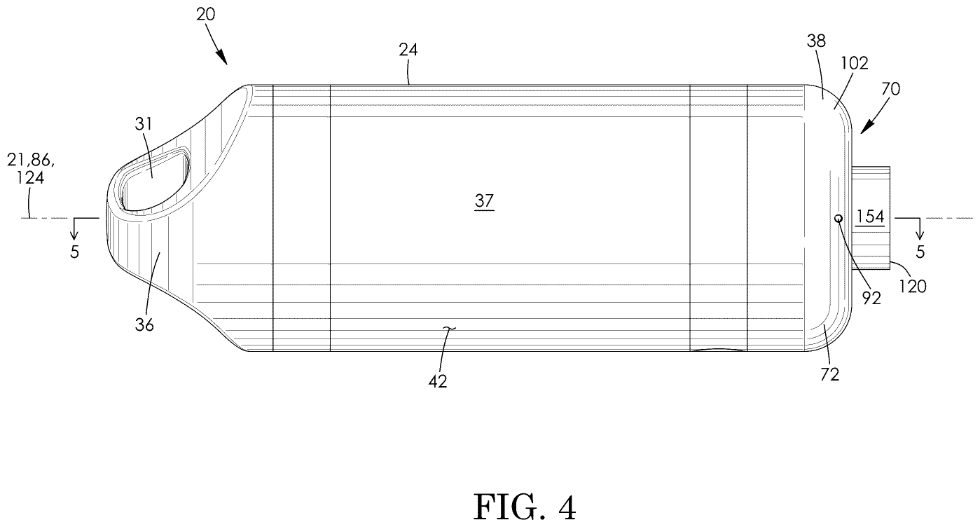

FIG. 5 is a cross-sectional view taken along lines 5-5 of the gas cylinder assembly and the quick-locking assembly of FIG. 4;

FIG. 6 is a bottom, right side perspective view of the pressurized gas cylinder and pressure regulator of the gas cylinder assembly of FIG. 1;

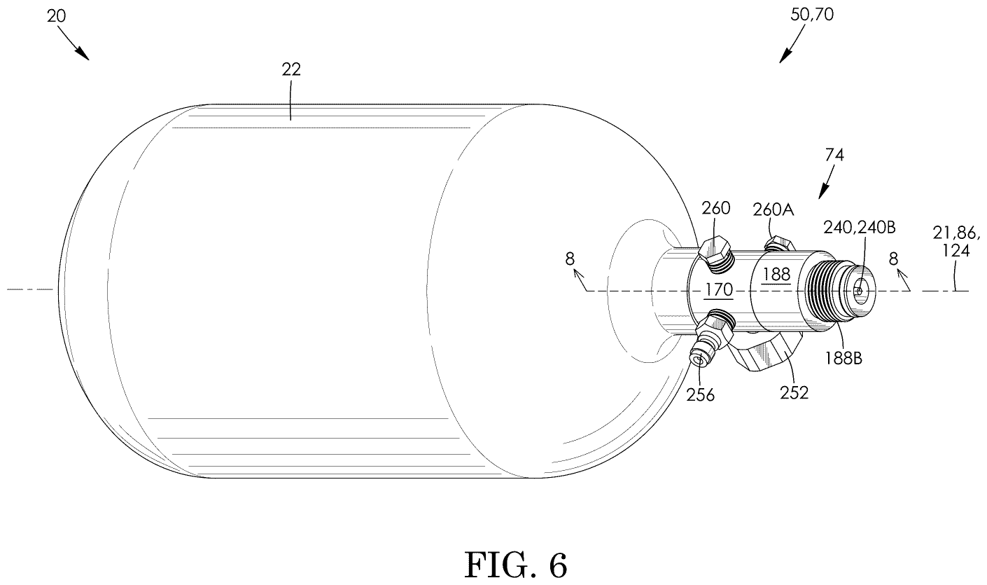

FIG. 7 is an exploded, distal end, side perspective view of the pressure regulator of FIG. 6;

FIG. 8 is an enlarged sectional view taken along lines 8-8 of the gas cylinder assembly and pressure regulator of FIG. 6, with the gas cylinder assembly being shown in fragment and with the pressure regulator being shown in a closed position;

FIG. 9 is an enlarged sectional view of the pressure regulator of FIG. 8, with the pressure regulator being shown in an actuated position;

FIG. 10 is a front, right side perspective view of the gas cylinder assembly and the first coupling member of the quick locking assembly of FIG. 1, with the gas cylinder assembly being shown in fragment;

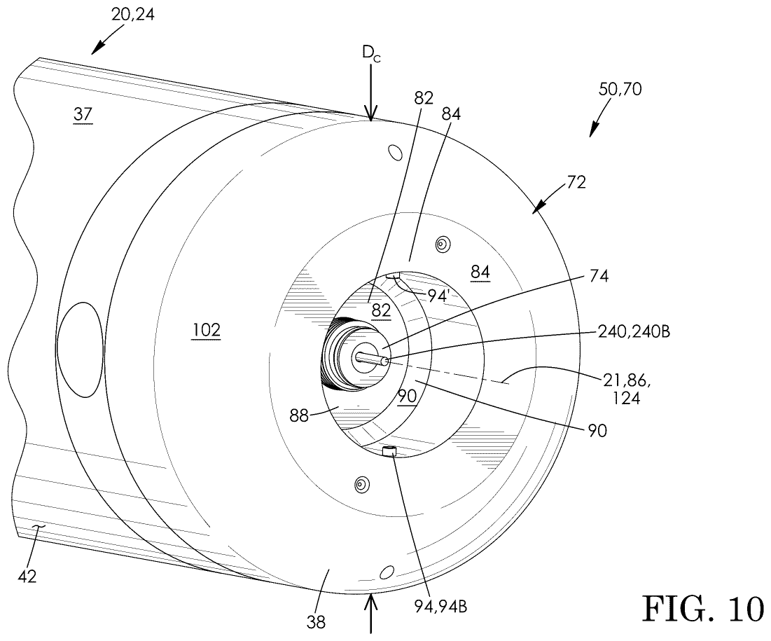

FIG. 11 is a front, right side perspective view of the gas cylinder assembly and the first coupling member of the quick locking assembly of FIG. 1, with the gas cylinder assembly being shown in fragment and partially in ghost;

FIG. 12A is a right side elevation view of the gas delivery system and the second coupling member of the quick locking assembly of FIG. 1; and

FIG. 12B is a bottom plan view thereof.

### DESCRIPTION OF THE PREFERRED EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

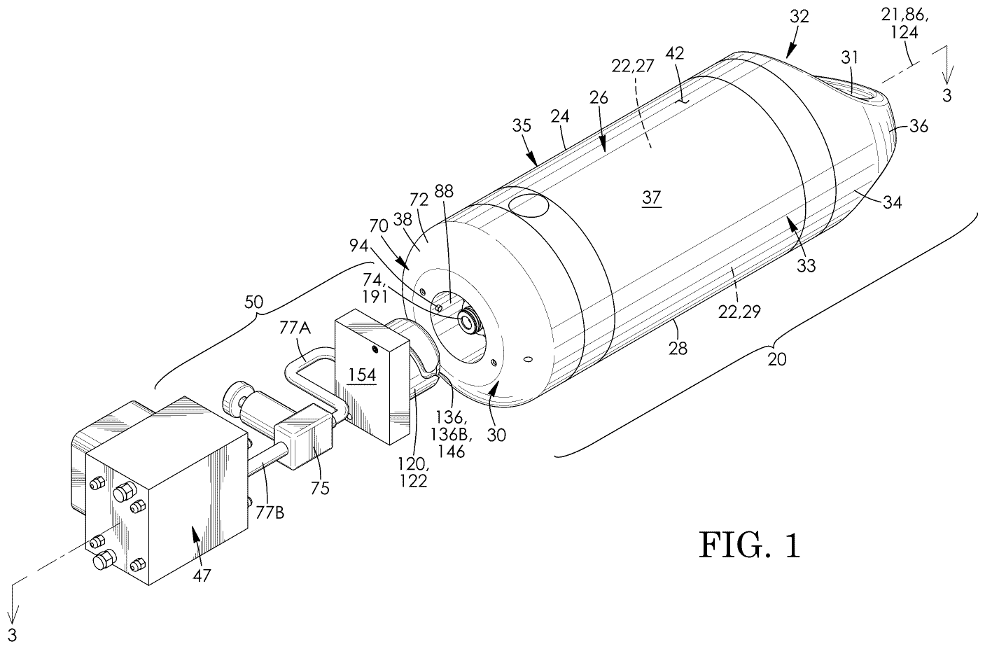

Referring to the drawings and first to FIG. 1, there is provided a gas cylinder assembly 20. The gas cylinder assembly is elongate and extends along a longitudinal axis 21. Gas cylinder assembly 20 includes a housing, in this example a gas cylinder housing 24. The housing may be referred to as a gas cylinder cover. The gas cylinder housing extends about and is co-axial with longitudinal axis 21 in this example. Gas cylinder housing 24 has a top 26, a bottom 28 spaced-apart from the top thereof, a front 30, a rear 32 spaced-apart from the front thereof and a pair of spaced-apart sides 33 and 35 extending between the bottom and top thereof. The gas cylinder housing is generally elongate and cylindrical in outer shape in this non-limiting example. Gas cylinder housing 24 has an exterior or outer surface 42 extending between front 30 and rear 32 thereof.

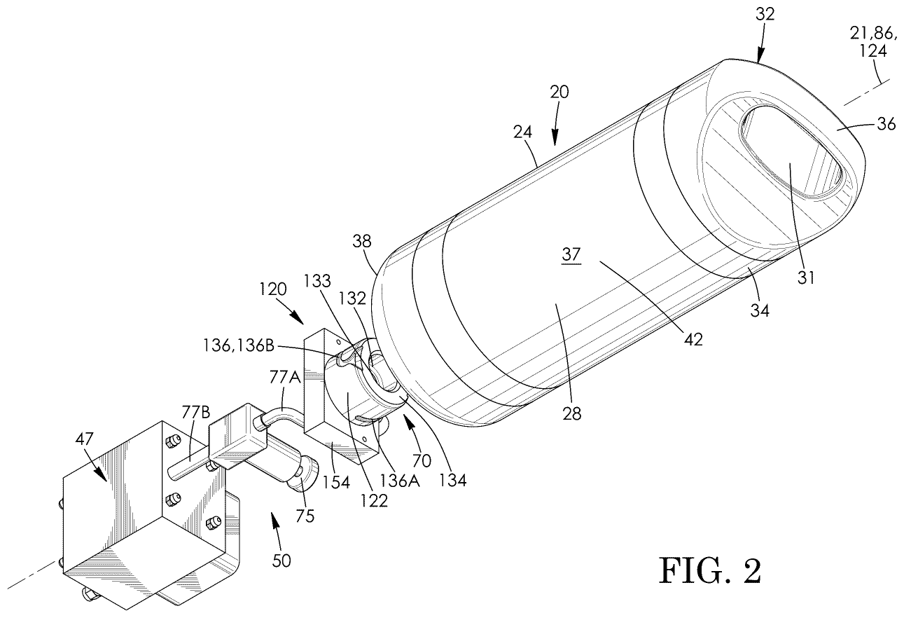

The gas cylinder housing includes a first end portion 34 adjacent rear 32 thereof. The first end portion of gas cylinder housing 24 extends from the rear towards front 30 of gas cylinder housing 24 in this non-limiting example. The gas cylinder housing is shaped to facilitate gripping thereof in this example. As seen in FIG. 2, gas cylinder housing 24 includes a handle 36 in this non-limiting embodiment which achieves this functionality; however, this is not strictly required. The handle is positioned adjacent first end portion 34 of the gas cylinder housing. Opening 31 extends through the first end portion of gas cylinder housing 24 in this non-limiting example to form handle 36 in part and facilitate said gripping.

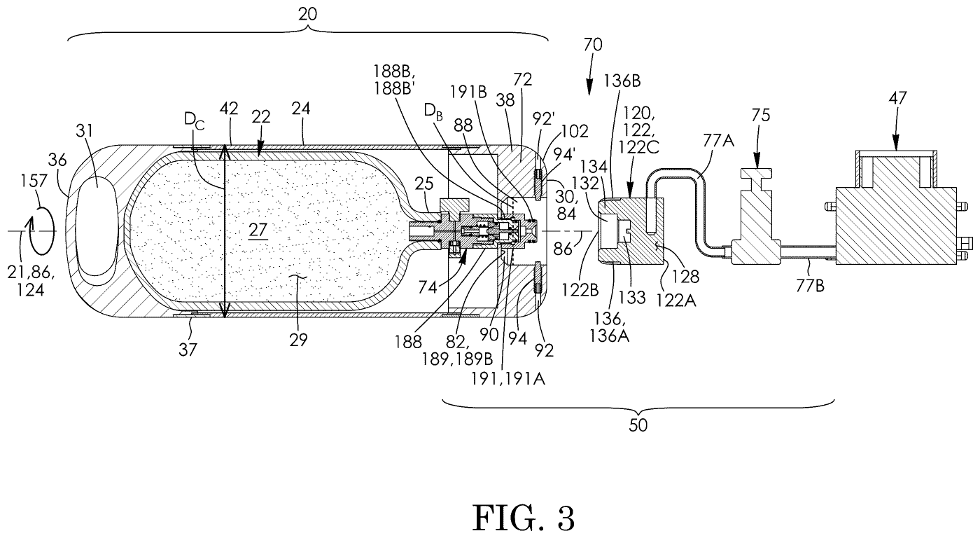

The gas cylinder housing includes a body or central portion 37 which is elongate and extends about longitudinal axis 21. The central portion of gas cylinder housing 24 couples to and extends outwards from end portion 34 of the gas cylinder housing. Central portion 37 of the gas cylinder housing is substantially a cylinder in outer shape in this non-limiting embodiment. As seen in FIG. 3, the central portion of the gas cylinder housing has an outer diameter D_{C}.

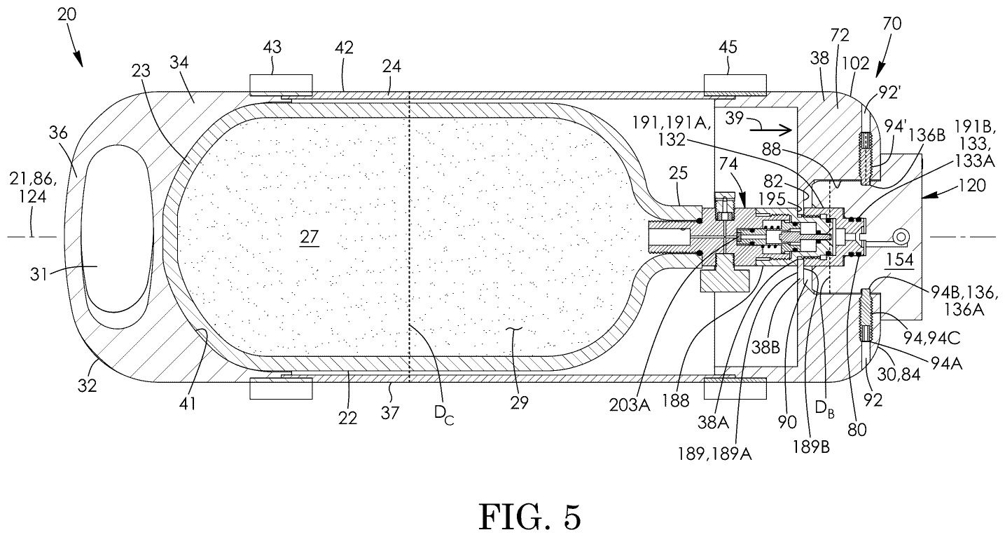

Referring to FIG. 5, gas cylinder housing 24 includes a second end portion 38 adjacent front 30 thereof and extending from the front towards rear 32 thereof. The second end portion of the gas cylinder housing is longitudinally spaced from first end portion 34 of the gas cylinder housing. Central portion 37 of gas cylinder housing 24 extends between and selectively couples together first and second end portions of the gas cylinder housing. Second end portion 38 of the gas cylinder housing tapers outwards from and relative to central portion 37 in this non-limiting example in a direction 39 extending from rear 32 to front 30 of the gas cylinder housing in this non-limiting embodiment. The second end portion of gas cylinder housing 24 is outwardly convex in part in this example. Second end portion 38 of the gas cylinder housing may thus be referred to as a tapered portion and/or an outwardly convex portion. End portions 34 and 38 of gas cylinder housing 24 are configured to selectively couple to opposite ends of central portion 37 of the gas cylinder housing, in this non-limiting example via a snap fit connection. However, this is not strictly required and in other embodiments the portions of the gas cylinder housing may couple together in other manners and/or only one of the end portions may be removeable with the other end portion being of the gas cylinder housing being integrally connected to the central portion of the gas cylinder housing so as to form a unitary whole, for example.

Gas cylinder assembly 20 includes in this non-limiting embodiment one or more mounts configured for coupling of the gas cylinder assembly to another structure (e.g. a wall, floor, chassis or the like), in this example in the form of at least one and in this case a pair of spaced-apart stabilizing members 43 and 45. Each stabilizing member is annular in this non-limiting example; however, this is not strictly required. Stabilizing members 43 and 45 are shaped to receive, extend about and couple to gas cylinder housing 24. In this non-limiting embodiment stabilizing member 43 is positioned between first end portion 34 and central portion 37 of the gas cylinder housing, and stabilizing member 45 is positioned between second end portion 38 and the central portion of the gas cylinder housing in this example; however, this is not strictly required.

Gas cylinder housing 24 is shaped to selectively receive therewithin and enclose a pressurized gas tank or cylinder 22. The gas cylinder is selectively accessible by uncoupling one of end portions 34 and 38 from central portion 37 of gas cylinder housing 24. Gas cylinder 22 is shaped to receive therein a fluid, in this non-limiting embodiment a pressurized gas, in this example hydrogen gas 27; however, the latter is not strictly required and other types of fluids and/or gases may be used in other embodiments. Gas cylinder 22 has an outwardly convex bottom 23. First end portion 34 of gas cylinder housing 24 has in this non-limiting example an inner surface 41 that is outwardly concave and shaped to snugly receive the bottom of the gas cylinder therewithin; however, this is not strictly required.

Gas cylinder 22 includes an outlet 25 axially spaced from and opposite bottom 23 thereof. The gas cylinder enables selective access via the outlet thereof to gas 27 stored within interior 29 thereof. Second end portion 38 of gas cylinder housing 24 is shaped to align with and/or be near or adjacent the outlet of the gas cylinder in this non-limiting example. Gas cylinder 22 so received within the gas cylinder housing, is thus selectively transportable via handle 36. Gas cylinder housing 24 is configured to inhibit access and/or damage to the gas cylinder and functions to secure/store the gas cylinder in place therewithin. Gas cylinders per se, with their various parts and functionings, are well known to those skilled in the art and gas cylinder 22 will accordingly not be described in further detail.

Referring back to FIG. 1, there is provided an electrochemical cell, in this example a fuel cell 47. The fuel cell is configured to convert chemical energy of gas 27 from gas cylinder 22 and an oxidizing agent (e.g. oxygen), into electricity via redox reactions. Fuel cells per se, including their various parts and functionings, are well known to those skilled in the art and fuel cell 47 will accordingly not be described in further detail.

There is further provided a gas delivery system 50 for gas cylinder assembly 20 via which gas 27 from gas cylinder 22 is delivered to fuel cell 47. As seen in FIG. 3, the gas delivery system includes at least one valve, in this non-limiting example first and second valves, in this case first and second pressure regulators 74 and 75. However, the latter is not strictly required and in other embodiments there may be provided only one pressure regulator. First pressure regulator 74 is selectively connectable to outlet 25 of gas cylinder 22 so as to be in fluid communication gas 27. Second pressure regulator 75 is in fluid communication with first pressure regulator 74 via a first conduit or tubing 77A and in fluid communication with fuel cell 47 in this example via a second conduit or tubing 77B.

First pressure regulator 74 is a hydrogen pressure regulator in this example. The first pressure regulator is a device configured to control and reduce the high pressure of hydrogen gas from a high-pressure source, such as compressed gas cylinder 22, to a lower and safer pressure suitable for a particular application. For example, first pressure regulator 74 may be configured to provide a pressure reduction by a factor of 50 or more, in this non-limiting example from 4500 PSI (pounds per square inch) to 80 PSI. The following is a non-limiting embodiment of the first pressure regulator which achieves this functionality.

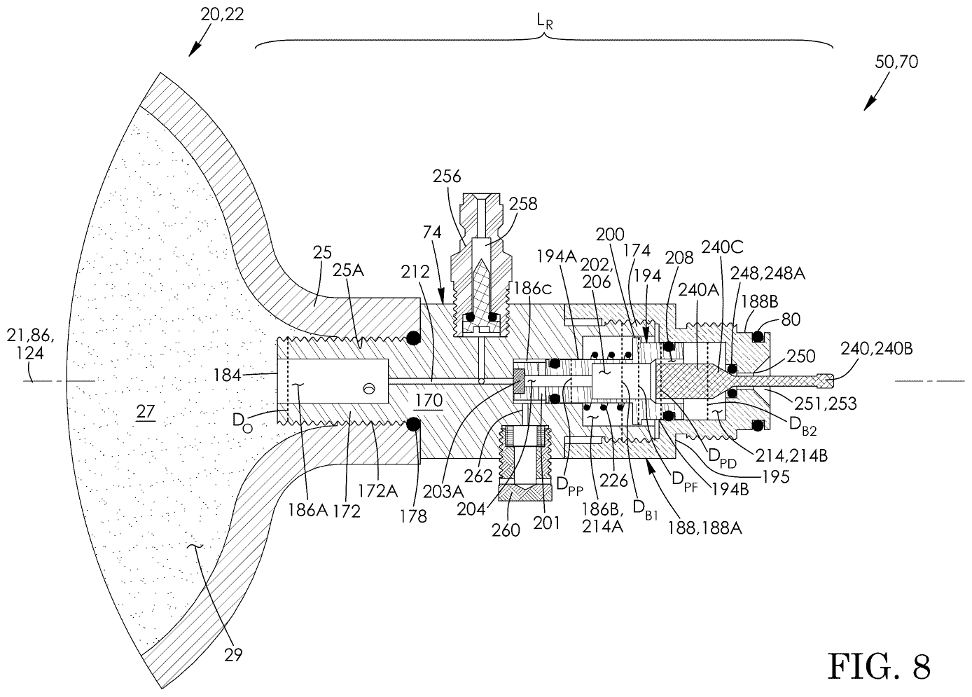

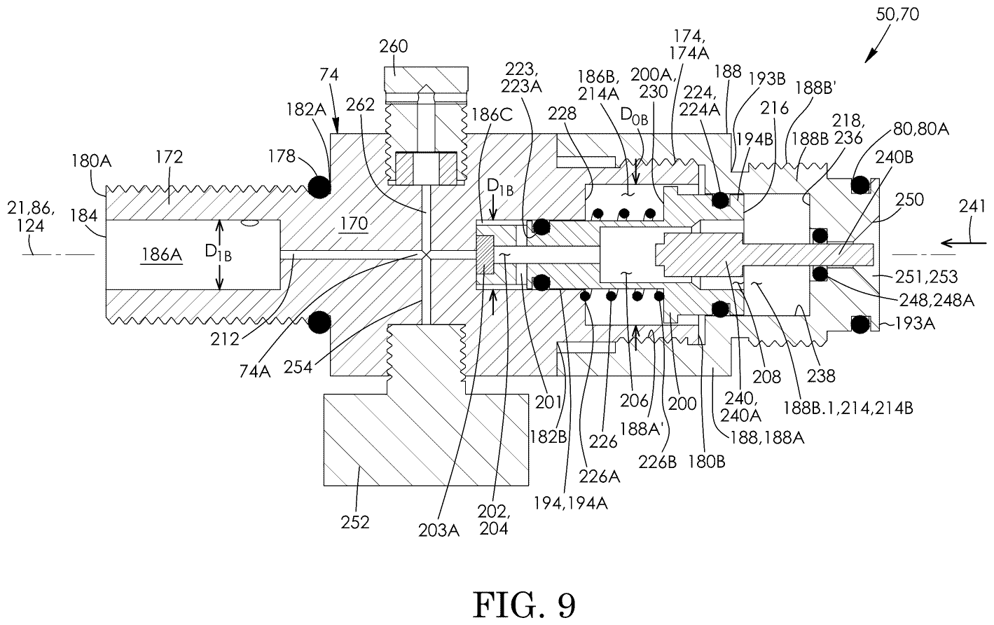

As seen in FIG. 9, first pressure regulator 74 includes a longitudinally-extending valve body 170 which extends along longitudinal axis 21 thereof. The valve body has a first end portion 172 and a second end portion 174 which is longitudinally spaced-apart from the first end portion thereof. Referring to FIG. 8, valve body 170 selectively couples to outlet 25 of gas cylinder 22 via the first end portion thereof, in this example via interior threading 25A of the outlet threadably coupling to exterior threading 172A of the first end portion of the valve body. First pressure regulator 74 sealably couples to the gas cylinder, in this example via a seal, in this case an O-ring 178 extending about first end portion 172 of valve body 170. The first pressure regulator is thus selectively and sealably connectable to gas cylinder 22. Referring back to FIG. 9, first end portion 172 of valve body 170 has a first or proximal end 180A and a second or distal end 182A longitudinally spaced-apart from proximal end 180A thereof. O-ring 178 is adjacent the distal end of the first end portion of the valve body in this non-limiting example.

First pressure regulator 74 has an opening, in this example, a regulator opening 184 adjacent proximal end 180A of first end portion 172 of valve body 170. The valve body has a first elongate bore, in this example an inlet bore 186A extending longitudinally through first end portion 172 thereof. The inlet bore extends from regulator opening 184 towards distal end 182A of the first end portion of the valve body. As seen in FIG. 8, inlet bore 186A is in fluid communication with gas 27 of gas cylinder 22. First end portion 172 and/or the inlet bore of valve body 170 may be referred to the inlet port of first pressure regulator 74 where high-pressure hydrogen gas enters the regulator from a high-pressure source, in this case gas cylinder 22.

The first pressure regulator includes an inlet port 256. The inlet port in this non-limiting example is positioned between end portions 172 and 174 of valve body 170. Inlet port 256 in this non-limiting embodiment threadably couples to the valve body. The inlet port extends laterally outwards from valve body 170. Inlet port 256 defines an inlet port flow path 258 which extends perpendicular to longitudinal axis 21.

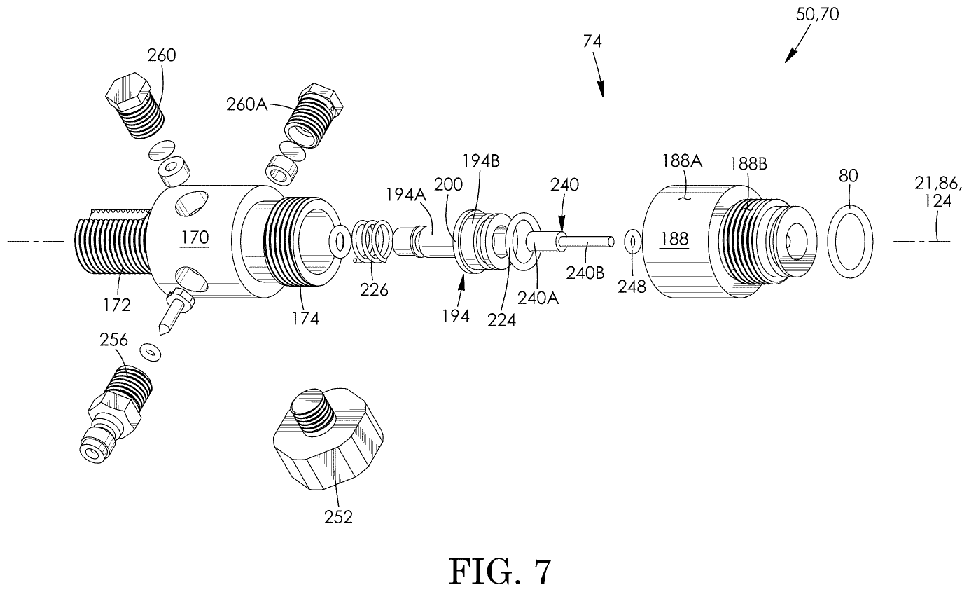

As seen in FIG. 7, first pressure regulator 74 includes one or more safety valves 260 and 260A. Each safety valve in this non-limiting example is positioned between end portions 172 and 174 of valve body 170. Safety valves 260 and 260A in this non-limiting embodiment threadably couple to the valve body. Each safety valve extends laterally outwards from valve body 170 relative to longitudinal axis 21 in this non-limiting example. As seen in FIG. 8, each safety valve 260 defines and/or is in fluid communication with a safety valve flow path 262 which extends perpendicular to longitudinal axis 21. Each safety valve is a device designed to release pressure from the system or vessel in order to prevent over-pressurization and potential damage or failure.

Referring back to FIG. 7, first pressure regulator 74 includes in this example a pressure gauge 252. The pressure gauge is configured to selectively couple to and extend outwards from valve body 170, in this example threadably coupling thereto; however, this is not strictly required. Pressure gauge 252 is in fluid communication with interior 74A of the first pressure regulator via an auxiliary flow path 254 seen in FIG. 9 and functions to measure the pressure therewithin. The auxiliary flow path extends laterally/radially outwards from longitudinal axis 21 in this non-limiting example. Pressure gauge 252 is configured to provide a visual indication of the pressure of the fluid being regulated and which is received via inlet bore 186A. Referring back to FIG. 7, safety valves 260 and 260A, inlet port 256 and pressure gauge 252 are circumferentially spaced-apart in this non-limiting example. Safety valves, inlet ports, and pressure gauges, including their various parts and functionings, are known per se and safety valves 260, inlet ports 256 and pressure gauges 252 will thus not be described in further detail.

As seen in FIG. 9, second end portion 174 of valve body 170 has a first or distal end 180B and a second or proximal end 182B longitudinally spaced-apart from proximal end 180B thereof. The valve body has a second elongate bore, in this example an outlet bore 186B extending longitudinally through second end portion 174 thereof. The outlet bore extends from distal end 180B to proximal end 182A of the second end portion of valve body 170. The valve body has a third or intermediate bore 186C in fluid communication with and extending from outlet bore 186B thereof towards inlet bore 186A thereof. The intermediate bore has a diameter DIB smaller than diameter DOB of the outlet bore and generally or substantially equal to diameter DIB of the inlet bore in this non-limiting example.

First pressure regulator 74 includes a bonnet 188. The bonnet is generally tubular with an open proximal or first end portion 188A and a more closed, distal or second end portion 188B longitudinally spaced from the first end portion thereof. As seen in FIG. 8, the first end portion of bonnet 188 has an inner diameter D_{B1} and the second end portion of the bonnet has inner diameter D_{B2} in a region adjacent thereto, with said inner diameter of the second end portion being less than said inner diameter of the first end portion of the bonnet. The bonnet includes an annular, exterior shoulder 195 extending laterally outwards from second end portion 188B to first end portion 188A thereof. As seen in FIG. 5, bonnet 188 is shaped to extend through a proximal or inner bore 38A of second end portion 38 of gas cylinder housing 24 such that an inner surface 189A of inwardly-extending annular flange 189 of the second end portion of the gas cylinder housing abuts shoulder 195 thereof. The inner surface of the flange may be referred to as an interior surface of the gas cylinder housing.

Referring back to FIG. 9, bonnet 188 is configured to threadably couple to valve body 170, in this example via interior threading 188A′ of first end portion 188A thereof threadably coupling to exterior threading 174A of second end portion 174 of the valve body. The bonnet is thus configured to selectively couple to and enclose at least in part the second end portion of the valve body.

Second end portion 188B of bonnet 188 in this non-limiting example has a first or distal end 193A, a second or proximal end 193B axially spaced from the proximal end thereof, and exterior threading 188B′ between the ends thereof. The second end portion of the bonnet is configured to receive a seal, in this example an O-ring 80 extending thereabout. The O-ring is seated within an annular groove 80A of second end portion 188B of bonnet 188 adjacent distal end 193A of the second end portion of the bonnet. The bonnet may be referred to as a female male adapter with a female portion or end portion 188A and a male portion or end portion 188B.

Still referring to FIG. 9, first pressure regulator 74 includes a chamber 214. The chamber in this non-limiting example is located within and formed by a proximal or interior bore 188B.1 of second end portion 188B of bonnet 188 and outlet bore 186B of second end portion 174 of valve body 170.

First pressure regulator 74 includes a piston 194. The piston has a first or proximal portion 194A, a second or distal portion 194B spaced-apart from the proximal portion thereof, and a protrusion portion or annular flange 200 extending between the portions thereof. Each said portion of piston is cylindrical in outer shape in this example. As seen in FIG. 8, distal portion 194B of piston 194 has an outer diameter D_{PD} that is greater than outer diameter D_{PP} of proximal portion 194A of the piston. Flange 200 has an outer diameter D_{PF} greater than the diameters of both portions of piston 194.

Referring back to FIG. 9, proximal portion 194A of piston 194 is received by and slidable and/or longitudinally moveable relative to intermediate bore 186C of valve body 170. The proximal portion of the piston sealably engages with the valve body via a first or distal O-ring 223. The O-ring extends about proximal portion 194A of piston 194 and is seated/positioned in place via an annular groove 223A.

Distal portion 194B of piston 194 is slidable and/or longitudinally moveable relative to second end portion 188B of bonnet 188. The distal portion of the piston sealably engages with the second end portion of the bonnet via a first or distal O-ring 224. The O-ring extends about distal portion 194B of piston 194 and is seated/positioned in place via an annular groove 224A. Bonnet 188 and valve body 170 threadably couple together so as to seal first pressure regulator 74 as a whole/unit.

Piston 194 has a longitudinally-extending passageway 202 extending centrally therethrough. The passageway in this non-limiting embodiment includes: proximal or first bore 203; an intermediate or second bore 204 adjacent to, downstream of and in fluid communication with the first bore thereof; an intermediate or third bore 206 adjacent to, downstream of, and in fluid communication with the second bore thereof; and a distal or fourth bore 208 adjacent to, downstream of, and in fluid communication with the third bore thereof. Each bore is annular in this non-limiting example. First bore 203 is enlarged relative to second bore 204 in this non-limiting example. Third bore 206 has a diameter larger than that of the first and second bores and fourth bore 208 has a diameter larger than that of the first, second and third bores in this non-limiting embodiment.

As seen in FIG. 9, first pressure regulator 74 includes a central, main or primary flow path 212. Safety valve 260 in this example is in fluid communication with the primary flow path via safety valve flow path 262 which extends radially outwards therefrom. Pressure gauge 252 in this example is in fluid communication with primary flow path 212 via auxiliary flow path 254 which extends radially outwards therefrom. The primary flow path fluidly communicates with and longitudinally extends between bores 186A and 186C/203. Primary flow path 212 of the first pressure regulator is longitudinally extending and coaxial with longitudinal axis 21 in this non-limiting example. Referring to FIG. 8, when first pressure regulator 74 is at least partially in its open position, gas 27 from gas cylinder 22 passes through primary flow path 212 and through bores 203, 204, 206 and 208.

Referring back to FIG. 9, chamber 214 is adjacent to and downstream of piston 194. The chamber is configured to be in fluid communication with fourth bore 208 and thereby passageway 202. Distal portion 194B and flange 200 of piston 194 are located within and received by chamber 214. The distal portion and flange of the piston are configured to separate the chamber into a proximal, first or upstream sub-chamber 214A and a distal, second or downstream sub-chamber 214B. The upstream sub-chamber may be referred to as a low pressure region and the downstream sub-chamber may be referred to as a regulated pressure region. The downstream sub-chamber is configured to be in fluid communication with passageway 202 of piston 194.

Downstream sub-chamber 214B has a moveable first or proximal end 216 formed by distal portion 194B of piston 194 and a second or distal end 218 formed by an annular, inner surface 236 of second end portion 188B of bonnet 188. The distal end of the downstream sub-chamber is spaced-apart from the proximal end of the downstream sub-chamber. Downstream sub-chamber 214 includes an annular inner wall 238 formed by the interior of bonnet 188 and which extends between ends 216 and 218 thereof.

Upstream sub-chamber 214A has a first or proximal end 228 formed by an annular, inner surface of second end portion 174 of valve body 170 in this example, and a moveable second or distal end 230 formed by an annular, inner surface 200A of flange 200 in this example. The distal end of the upstream sub-chamber is longitudinally spaced from the proximal end of the upstream sub-chamber. The size/volumeric-extent of sub-chambers 214A and 214B is configured to be variable: varying based on longitudinal positioning of piston 194 therewithin/relative-thereto. O-ring 223 is configured promote passage of gas from primary flow path 212 through passageway 202 of piston 194. O-ring 224 is configured to seal off sub-chambers 214A and 214B from each other and/or inhibit fluid communication therebetween.

Piston 194 is spring-biased towards downstream sub-chamber 214B in this example via a resilient member, in this case a coil spring 226. The spring extends about proximal portion 194A of piston 194 and is positioned within upstream sub-chamber 214A. Spring 226 has a proximal end 226A and a distal end 226B spaced-apart from the proximal end thereof. The proximal end of the spring is adjacent to and abuts proximal end 228 of upstream sub-chamber 214A in this example. Distal end 226B of spring 226 is adjacent to and abuts inner surface 200A of flange 200.

First pressure regulator 74 includes a valve member 240. The valve member may be referred to as a plunger or a pin valve. Valve member 240 is elongate and generally cylindrical in outer shape in this non-limiting example. The valve member has a length equal to or less than two inches in this non-limiting embodiment; As seen in FIG. 8, the valve member has a first or proximal portion 240A, a second or distal portion 240B spaced apart from the proximal portion thereof, and in this example a tapered portion 240C extending between the proximal and distal portions thereof. The tapered portion of the valve member tapers in a direction extending from the proximal portion to the distal portion of the valve member. Valve member 240 is configured such that first portion 240A thereof is located at least in part within fourth bore 208 and distal portion 240B thereof is received at least in part by second end portion 188B of bonnet 188.

The distal portion of the valve member is slidable and/or longitudinally moveable relative to second end portion 188B of bonnet 188. Distal portion 240B of valve member 240 sealably engages with the second end portion of the bonnet via a valve member seal, in this example an O-ring 248. The O-ring extends about the distal portion of the valve member and is seated/positioned in place via a recess or bore 248A. The bore is in fluid communication with and adjacent sub-chamber 214B.

As seen in FIG. 9, bonnet 188 has a valve bore 250 extending therethough adjacent inner surface 236 thereof. The valve bore is shaped to slidably receive distal portion 240B of valve member 240 therethrough. Valve bore 250 is in fluid communication with downstream sub-chamber 214B. First pressure regulator 74 includes an outlet port 251 of which valve bore 250 is a feature thereof. Inlet port or first end portion 172 of valve body 170 and outlet port 186 (and/or second end portion 174 of the valve body) align along longitudinal axis 86. The outlet port has an outer bore 253 that is outwardly flared in this non-limiting example. Distal portion 240B of valve member 240 is extendable at least in part through the outer bore in an extended or closed position of the valve member. The valve member is configured to inhibit exiting of fluid from bonnet 188 in the closed position thereof until the valve member is retracted longitudinally inwards, as shown by arrow 241, in this non-limiting example into third bore 206 of piston 194, so as to enable passage of gas through bores 250 and 253.

In operation and referring to FIG. 8, high pressure gas 27 passing through inlet port 186A extends through flow path 212 and through one or more radially/laterally-extending bores 201 extending through proximal portion 194A of piston 194 so as to enable fluid communication between inlet bore 186A of valve body 170 and passageway 202 when the piston is biased towards a forward position to the right relative to FIG. 8. This thus provides a flow path when the piston is dislodged from seat or disk 203A. Referring to FIG. 9, pressure within sub-chamber 214B thereafter causes force to be exerted in the upstream direction on piston 194 via proximal end 216 of downstream sub-chamber 214B. When said force exceeds the force of spring 226 being exerted on flange 200 and thus the piston in the downstream direction, piston 194 moves in the upstream direction. When piston 194 moves in the upstream direction, spring 226 is compressed, upstream sub-chamber 214A is reduced in size, and downstream sub-chamber 214B is expanded thereby lowering pressure in the downstream chamber. A sealing member or disk 203A may be provided to inhibit flow at this stage/position-of-piston through first pressure regulator 74. Spring 226 may be referred to or be part of as a pressure-reducing mechanism. The spring, including its size and shape thereof, is thus configured to reduce the high pressure of hydrogen gas from a high-pressure source, such as compressed gas cylinder 22, to a lower and safer pressure, such as 80 psi in this non-limiting example.

Thus, when the high-pressure hydrogen gas enters first pressure regulator 74 (via an inlet port or first end portion 172 and/or inlet bore 186A of valve body 170), the gas pushes against the diaphragm or piston 194, which triggers the pressure-reducing mechanism or spring. The pressure-reducing mechanism controls the flow of hydrogen gas and reduces its pressure to the desired level, typically 80 psi in this case. The reduced-pressure hydrogen gas then exits first pressure regulator 74 through outlet port 251 and is available for use in the specific application that requires the lower pressure.

When the force exerted on piston 194 in the upstream direction by pressure inside downstream sub-chamber 214B is weaker than the force exerted in the downstream direction on the piston by the spring (e.g. when valve member 240 is moved axially to open), the piston moves in the downstream direction. When piston 194 moves in the downstream direction, spring 226 expands, upstream sub-chamber 214A expands, and downstream sub-chamber 214B compresses thereby increasing pressure in the downstream chamber.

First pressure regulator 74 as herein described may be relatively low cost and comprise a particularly compact design. The first pressure regulator as herein described may thus be referred to as a straight-line regulator with inlet and outlet ports angularly spaced by substantially 180 degrees. Pressure control is thus achieved via properties and dimensions of first pressure regulator 74, including spring 226 and valve member 240 thereof. The valve member functions as a sealable flow path from the first pressure regulator to one or more downstream components.

First pressure regulator 74 per se is not strictly required and other types of pressure regulators may be used in other embodiments, such as that shown in U.S. Pat. No. 6,851,447 to Carroll, the disclosure of which is incorporated herein by reference.

As seen in FIG. 8, first pressure regulator 74 has a length LR. The length of the regulator is equal to less than 5 inches in one non-limiting embodiment. In another non-limiting embodiment, length LR is equal to or less than 2.5 inches. In a further non-limiting embodiment, length LR is equal to or less than 2 inches.

Referring to FIG. 3, the first pressure regulator selectively couples to second end portion 38 of gas cylinder housing 24 via a pressure regulator mount 191 (which may but need not be considered part of the first pressure regulator). The following is a non-limiting embodiment which achieves this functionality.

Pressure regulator mount 191 is generally tubular with an open proximal or first end portion 191A and a more closed, distal or second end portion 191B longitudinally spaced from the first end portion thereof. The first end portion of the mount has an inner diameter which is larger than that of the second end portion of the mount and is shaped to receive at least in part second end portion 188B of bonnet 188. Mount 191 threadably couples to the second end portion via its exterior threading 188B′, such that the mount abuts an outer surface 189B of flange 189. First pressure regulator 74 is thus fixedly coupled to and positioned in place relative to cylinder housing 24 thereby. Mount 191 may be referred to as a second valve bonnet or bonnet or a longitudinally-extending first male member. In addition or alternatively, the mount may be referred to as a female adapter shaped to couple to a male portion or end portion 188B of the female male adapter or bonnet 188 and abut an exterior surface of the housing opposite the interior surface of the housing, in this example outer surface 189B of flange 189, with the female adapter having a proximal or inner end shaped to said surface.

As seen in FIG. 1, gas delivery system 50 includes a quick locking assembly 70 via which gas cylinder 22 and fuel cell 47 selectively operatively couple together. The quick locking assembly also functions to selectively operatively couple together first pressure regulator 74 and second pressure regulator 75. The following is a non-limiting embodiment of quick locking assembly 70 which achieves the above functionality.

Referring to FIG. 3, quick locking assembly 70 includes a first coupling member 72. The first coupling member may be referred to as a first coupling subassembly, a male coupling member and/or a first male member. Second end portion 38 of gas cylinder housing 24 may be said to comprise part of first coupling member 72 with outer diameter D_{C} of the gas cylinder housing thus being referred to as an outer diameter of the first coupling member; however, this is not strictly required. Gas cylinder housing 24 may thus be said to comprise at least part of quick locking assembly 70; however, this too is not strictly required and first coupling member 72, including second end portion 38, may be separate from end portion 38 and be configured to selectively couple to gas cylinder housing 24 in other embodiments.

First coupling member 72 has a first or proximal end 82, a second or distal end 84 spaced-apart from the proximal end thereof and a longitudinal axis 86 extending between the ends thereof. The distal end of the first coupling member aligns with front 30 of gas cylinder housing 24 in this non-limiting example. First coupling member 72 has a primary bore 88 extending from distal end 84 towards proximal end 82 thereof and which is coaxial with longitudinal axis 86. The primary bore has a diameter D_{B} seen in FIG. 5 which is less than half of that of outer diameter D_{C} of the gas cylinder housing in this example; however, this is not strictly required. Primary bore 88 is shaped to receive therewithin pressure regulator mount 191 as well at least part of second end portion 84 of first pressure regulator 74.

First coupling member 72 has an interior beveled shoulder 90 in fluid communication with primary bore 88 in this example; however, this is not strictly required. The beveled shoulder is adjacent proximal end 82 of the first coupling member.

First coupling member 72 has one or more auxiliary bores, in this example a pair of circumferentially spaced-apart and radially-extending bores 92 and 92′. However, this is not strictly required and fewer or additional auxiliary bores may be provided in other embodiments. Auxiliary bores 92 align with and extend within second end portion 38 of gas cylinder housing 24. The auxiliary bores are near and/or adjacent distal end 84 of first coupling member 72 in this non-limiting embodiment; however, this is not strictly required.

Quick locking assembly 70 includes one or more elongate or locking members, in this example protrusions in this case a pair of protrusions 94 and 94′. However, this is not strictly required and fewer or more protrusions may be provided in other embodiments. Each protrusion 94 may be referred to as a plunger or a locking plunger. Alternatively, the one or more protrusions may be referred to as one or more laterally-inwardly extending second male members operatively connected to and in this example extending perpendicular to the first male member or first pressure regulator 74. The protrusions extend laterally/radially relative to longitudinal axis 86 in this non-limiting example.

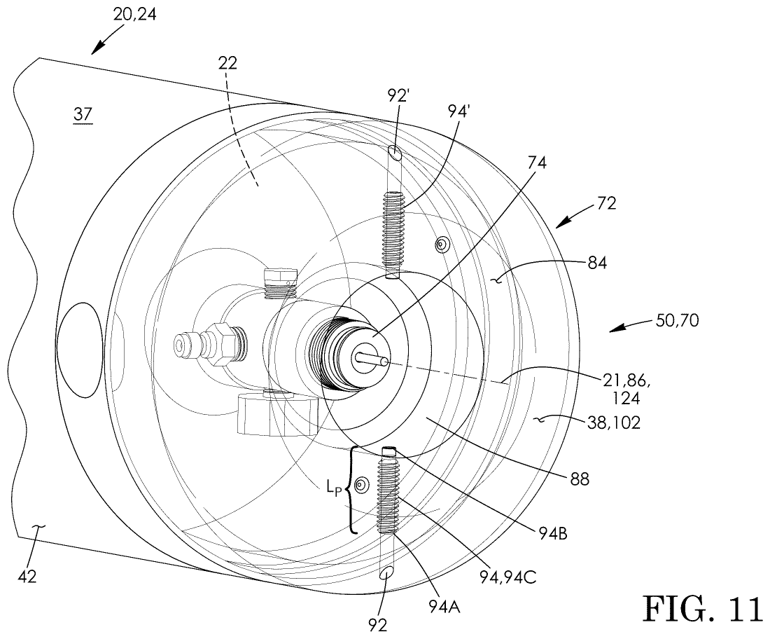

As seen in FIG. 11, each protrusion 94 includes a proximal end portion 94A, a distal end portion 94B spaced-apart from the proximal end portion thereof, and an elongate portion 94C between the end portions thereof. Each protrusion 94 has a length L_{P} extending between the ends thereof.

Each protrusion 94 extends radially-inwards within primary bore 88 at least in part. The protrusions are positioned adjacent to and spaced from distal end 84 of first coupling member 72 in this example. Protrusions 94 align with and are adjacent to second end portion 38 of gas cylinder housing 24 in this non-limiting embodiment. The protrusions thus align with tapered/outwardly-convex portions of the gas cylinder housing in this example, which may be referred to as tapered/outwardly-convex portions 102 of first coupling member 72.

Each protrusion 94 couples to first coupling member 72 (including operatively connecting to first pressure regulator 74) and thus gas cylinder housing 24. Alternatively, the first coupling member and/or the gas cylinder housing may be said to include the protrusions. In this example each protrusion 94 couples to gas cylinder housing 24 via a respective auxiliary bore 92. Each auxiliary bore is shaped to receive and extend about proximal end portion 94A and elongate portion 94C of a respective protrusion. For each protrusion 94 only distal end 94B portion thereof extends within primary bore 88 of first coupling member 72 in this example. Protrusions 94 are thus substantially enclosed by the first coupling member.

The protrusions are selectively adjustable, in this example selectively adjustable laterally/radially relative to longitudinal axis 86 of first coupling member 72. Each protrusion extends laterally and is axially fixed relative to the longitudinal axis of the first coupling member. The following is a non-limiting embodiment that achieves this functionality.

Protrusions 94 in this example threadably couple and are adjustable relative to first coupling member 72 via auxiliary bores 92. The extent to which the protrusions extend radially inwards within primary bore 88 is threadably adjustable by engaging proximal end portions 94A of the protrusions via a drill bit (not shown), for example. This causes the extent to which distal end portions 94B extend into bore 88 to be variable/adjustable. Each protrusion 94 is radially inwardly spaced from outer surface 42 of gas cylinder housing 24 and thus inwardly spaced from the outer surface of first coupling member 72 in this non-limiting embodiment.

For each protrusion 94, length L_{P} thereof is in the range of equal to or greater than one third of outer diameter D_{B} of the primary bore seen in FIG. 5 and equal to or less than one half of the outer diameter of the primary bore in this example; however, this is not strictly required and the protrusions may be longer or shorter in other embodiments.

As seen in FIG. 1, quick locking assembly 70 includes a second coupling member 120. The second coupling member may be referred to as a second coupling subassembly. Second coupling member 120 is selectively connectable to and in fluid communication with first coupling member 72.

The second coupling member is shaped to be selectively received within and shaped to selectively facilitate rotation thereof within primary bore 88 of the first coupling member. The following non-limiting embodiment achieves this functionality.

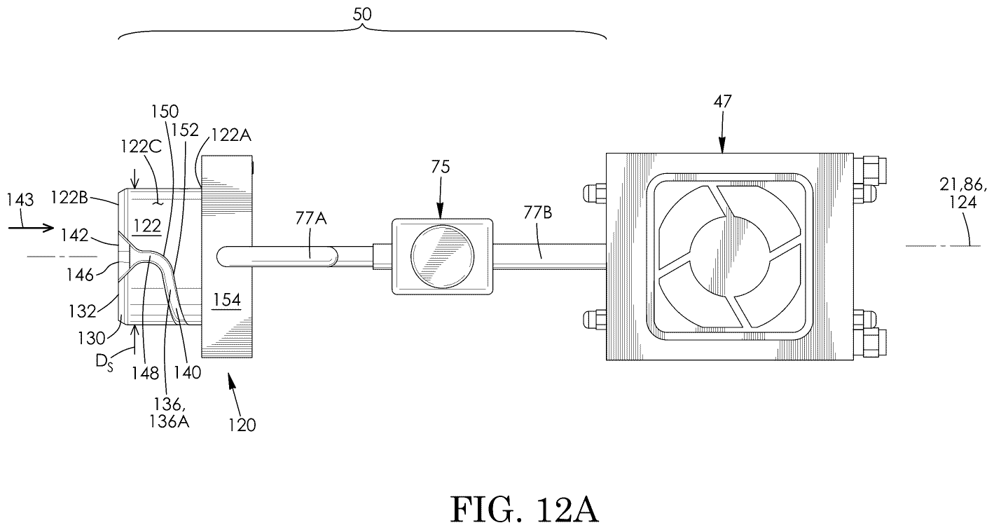

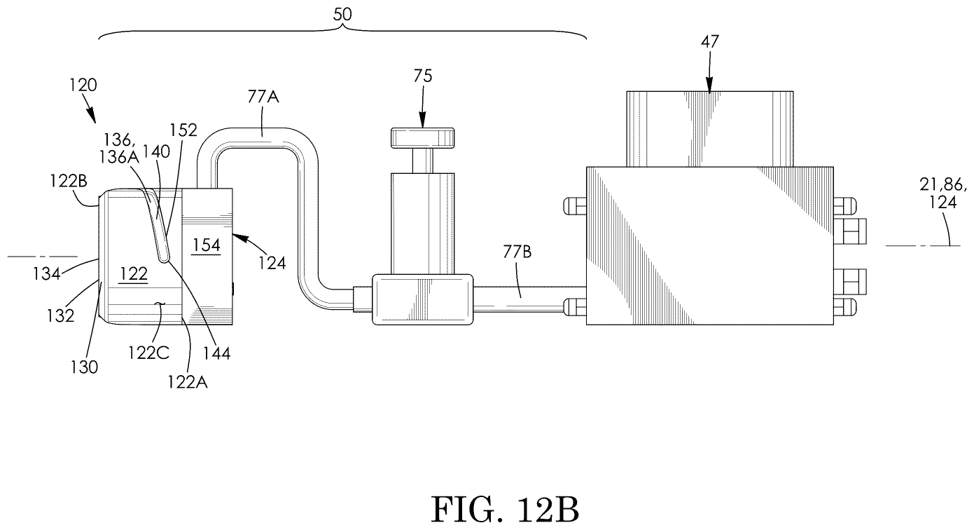

As seen in FIG. 12A, second coupling member 120 is substantially cylindrical in outer shape in this example. The second coupling member includes a body 122. The body of second coupling member 120 has a first or proximal end 122A, a second or distal end 122B, a longitudinal axis 124 extending between the ends thereof and an exterior or outer surface 122C extending between the ends thereof. The longitudinal axis of body 122 aligns with and in this non-limiting embodiment is co-axial with axes 21 and 86. The body of second coupling member 120 has an outer diameter D_{S}. For each protrusion 94 seen in FIG. 11 length L_{P} thereof is in the range of equal to or greater than one third of outer diameter D_{S} of body 122 of second coupling member 120 seen in FIG. 12A and equal to or less than one half of the outer diameter of the body of the second coupling member in this non-limiting example; however, this is not strictly required and the protrusions may be longer or shorter in other embodiments.

Still referring to FIG. 12A, body 122 of second coupling member 120 in this non-limiting embodiment has an outer bevelled shoulder 130 adjacent distal end 122B thereof. As seen in FIG. 5, the outer bevelled shoulder may be shaped to abut and/or extend adjacent to inner beveled shoulder 90 of first coupling member 72 when the coupling members are fully coupled together.

As seen in FIG. 3, body 122 of second coupling member 120 has a distal or first bore 132 extending from distal end 122B towards proximal end 122A thereof and a proximal or second bore 133 in fluid communication with the first bore thereof. As seen in FIG. 5, bore 132 is shaped to extend about and snugly receive first end portion 191A of pressure regulator mount 191 and bore 133 is shaped to extend about and snugly receive second end portion 191B of the pressure regulator mount when coupling members 72 and 120 are mated together. The pressure regulator mount (and/or first pressure regulator 74) may be said to be a part of the first coupling member in this non-limiting embodiment; however, this is not strictly required. Referring back to FIG. 3, body 122 of second coupling member 120 may be said to include a first female portion 134 (comprised of bores 132 and 133) shaped to couple with pressure regulator mount 191 (and/or first pressure regulator 74). The second coupling member as described to this stage may be referred to as a first female member shaped to mate with the first male member, pressure regulator mount and/or first pressure regulator.

As seen in FIG. 5, pressure regulator mount 191 sealably couples to second coupling member 120, in this example via one or more seals, in this case a pair of axially-spaced O-rings 80 extending about second end portion 191B thereof. The O-rings are positioned to abut and sealably engage with an inner annular wall 133A of the second coupling member extending about bore 133 in this example when the pressure regulator mount is fully inserted into bores 132 and 132 of body 122 of second coupling member 120 in this example. First pressure regulator 74 is thus operatively sealably connectable to the second coupling member.

As seen with reference to FIGS. 3 and 5, body 122 of second coupling member 120 is shaped to selectively fit at least in part within primary bore 88 of first coupling member 72. Protrusions 94 are shaped to engage second coupling member 120 so received within the primary bore of the first coupling member. The following is a non-limiting embodiment which achieves this functionality.

As seen in FIG. 3, body 122 of second coupling member 120 includes one or more second female portions, in this non-limiting embodiment one or more pathways, in this example a pair of circumferentially spaced-apart pathways 136A and 136B. However, this is not strictly required and fewer or more pathways may be provided in other embodiments. Second coupling member 120 may but need not be referred to as a female coupling member. Pathways 136A and 136B extend along and radially inwards relative to outer surface 122C of body 122 of second coupling member 120 from distal end 122B towards proximal end 122A of the body. As seen in FIG. 12A, each pathway is in the form of a groove 140 in this example which extends radially inwards from outer surface 122C of body 122 of second coupling member 120. Each pathway 136 may thus be referred to as an outer pathway. As seen in FIG. 2, pathways 136A and 136B are radially outwardly spaced from bores 132 and 133 of second coupling member 120. Each pathway is coupled to body 122 of second coupling member 120, including bores 132 and 133 thereof. Pathways 136A and 136B is integrally connected to the body of the second coupling member so as to form a unitary whole in this example.

As seen in FIGS. 3 and 5, protrusions 94 and 94′ are shaped to extend at least in part within and move along respective pathways 136A and 136B to enable/facilitate mating of second coupling member 120 with first coupling member 72. The one or more pathways may be referred to as one or more second female members shaped to receive one or more second male members or protrusions. Protrusions 94 and 94′ are configured to be received at least in part within pathways 136A and 136B when first coupling member 72 and second coupling member 120 are coupled together. In this example, the protrusions are configured such distal end portions 94B thereof extend within and engage with the pathways. The extent to which the distal end portions of protrusions 94 engage and/or are received within pathways 136A and 136B is adjustable by threadably adjusting the protrusions relative first coupling member 72 via engagement of proximal end portions 94A with a drill bit (not shown), for example. Pathways 136A and 136B are shaped to promote rotation of first coupling member 72 relative to second coupling member 120 when the coupling members are in the process of coupling together. Protrusions 94 and 94′ so positioned within the pathways are configured to inhibit decoupling the second coupling member from the first coupling member. The following non-limiting embodiment achieves this functionality.

Protrusions 94 and 94′ are shaped to frictionally engage with pathways 136A and 136B of second coupling member 120 at least in part in this non-limiting example. As seen in FIG. 12A, each pathway has a spiral shape in part and may thus be referred to as a spiral path or spiral pathway. Each pathway 136 has a first end 142 shaped to receive a respective protrusion therethrough. For each pathway the first end thereof is outwardly flared in this example. Each pathway has a second end 144 (seen in FIG. 12B for pathway 136A) spaced-apart from first end 142 thereof (see in in FIG. 12A for pathway 136A). For each pathway the second end thereof may be configured/shaped to function as a stop to inhibit a respective said protrusion from passing thereby.

Still referring to FIG. 12A, each pathway 136 has an enlarged mouth or recessed portion 146 extending from first end 142 thereof to second end 144 thereof (seen in FIG. 12B). Referring back to FIG. 12A, the enlarged recessed portion may be referred to as an enlarged opening. Enlarged recessed portion 146 is adjacent first end 142 of pathway 136. As seen in FIG. 1, each enlarged recessed portion is shaped to receive and facilitate/promote receiving of a corresponding protrusion 94 therewithin. Each enlarged recessed portion is thus shaped to receive a respective protrusion therein when pressure regulator mount 191 (and thus first pressure regulator 74) is inserted into second coupling member 120. The following is a non-limiting embodiment which achieves this functionality.

Referring to FIG. 12A, for each pathway 136 enlarged recessed portion 146 thereof tapers in a direction 143 extending axially from first end 142 thereof to second end 144 thereof (seen in FIG. 12B). As seen in FIG. 12A, enlarged recessed portion 146 is substantially triangular in side profile in this non-limiting embodiment.

Each pathway 136 includes a first or axially-extending passage 148 in fluid communication with enlarged recessed portion 146 thereof. The first passageways extend substantially parallel to longitudinal axes 21, 86 and 124 in this example. Each pathway 136 is arcuate-shaped at least in part. In this example each pathway includes an arcuate-shaped passage 150 coupled to and in fluid communication with axially-extending passage 148 thereof. Each arcuate-shaped passage extends laterally, circumferentially and axially at least in part. Each arcuate-shaped passage 150 extends in a coil or spiral shaped at least in part. Each pathway 136 is streamlined and has a smooth contour 152 in this example.

Referring to FIGS. 3 and 5, second coupling member 120 is shaped to inhibit actuation of first pressure regulator 74 until first coupling member 72 has rotated by a predetermined threshold relative to the second coupling member. Handle 36 of gas cylinder housing 24 is shaped to facilitate rotation of first coupling member 72 relative to second coupling member 120. The predetermined threshold in one non-limiting embodiment is substantially and/or at least 45 degrees; however, this is not strictly required and the predetermined threshold, or range thereof, may comprise a larger or smaller extent of angular rotation in other embodiments. Gas delivery system 50 (via in this example second coupling member 120) may be thus shaped to mate with the male members or mount 191 and protrusions 94 and 94′ so as to operatively connect to gas cylinder 22 via first pressure regulator 74 upon housing 24 rotating a predetermined threshold of rotation relative thereto.

Referring to FIG. 5, gas cylinder housing 24 may thus be said to be shaped via protrusions 94 to extend within and along pathways 136 when second coupling member 120 receives mount 191 to connect gas cylinder 22 to gas delivery system 50. The protrusions are configured to be downstream of bore 132 of second coupling member 120 when the first coupling member and second coupling member are so coupled together in this non-limiting example.

As seen in FIG. 1, second coupling member 120 includes an outwardly extending protuberance, in this example flange 154. The flange is coupled to body 122 of the second coupling member. As seen in FIG. 5, flange 154 of second coupling member 120 is shaped to abut distal end 84 of first coupling member 72 in this example when the first and second coupling members are fully coupled together. The flange in this non-limiting example is shaped to inhibit access to and enclose primary bore 88 when first coupling member 72 and second coupling member 120 are fully coupled together.

Referring to FIG. 3, the second coupling member operatively connects to second pressure regulator 75, in this example via conduit or tubing 77A. Bores 132 and 133 of second coupling member 120 are configured to be in fluid communication with the second pressure regulator. Second pressure regulator 75 is configured to further reduce pressure of the hydrogen gas in this non-limiting embodiment by an additional factor of 10: in this non-limiting embodiment from 80 PSI to 8 PSI. In this manner fuel cell 47 is thus provided with hydrogen gas at a pressure of 8 PSI, with gas delivery system 50 functioning to reduce pressure from 4500 PSI to 8 PSI therebetween in this non-limiting example. However, these factors and numbers are not strictly required and may be higher or lower in other embodiments. First pressure regulator 74 and/or second pressure regulator 75 are configured for variable output pressure control. The second pressure regulator may be an off-the-shelf product and pressure regulators per se, including their various parts and functionings, are known to those skilled in the art. Second pressure regulator 75 will thus not be described in further detail.

Quick locking assembly 70 as herein described may thus function to securely and quickly connect and disconnect high-pressure hydrogen cylinders 20 to and from gas delivery system 50. The quick locking assembly may thus be said to comprise two parts or sub-assemblies: 1) a valve or first pressure regulator 74 with mount 191 on the gas cylinder and coupled to gas cylinder housing 24; and 2) a mating fitting on the gas delivery system configured to selectively couple thereto. When gas cylinder 20 is inserted into said fittings, the locking mechanism engages, creating a secure connection that inhibits the gas cylinder from accidentally disconnecting.

Referring to FIG. 1, there is thus also provided herein a method for selectively connecting gas cylinder 22 to gas delivery system 50. Referring to FIG. 5, the method includes operatively connecting first pressure regulator 74 to gas cylinder 22, in this non-limiting example via a threaded connection. As seen in FIG. 3, the method includes enclosing gas cylinder 22 within gas cylinder housing 24 so to couple thereto. The method may include providing the gas cylinder housing with at least one and in this example a plurality of circumferentially spaced apart protrusions 94 and 94′ in fluid communication with first pressure regulator 74 and/or pressure regulator mount 191.

As seen in FIG. 3, the method includes operatively connecting second coupling member 120 to gas delivery system 50, in this example tubing 77A and 77B. Referring to FIG. 2, the method includes providing body 122 of the second coupling member with at least one and in this example a plurality of circumferentially spaced pathways 136A and 136B extending about outer surface 122C thereof. This providing step may include providing pathways that are spiral shaped at least in part.

Referring to FIGS. 3 and 5, the method includes operatively connecting together pressure regulator mount 191 (and/or first pressure regulator 74) and second coupling member 120. This step may include positioning/configuring protrusions 94 and 94′ so to be received at least in part within pathways 136A and 136B in this example via distal end portions 94B thereof. This step may further include selectively threadably adjusting positioning of the protrusions laterally relative to first coupling member 72 via engagement of proximal end portions 94A with a drill bit (not shown), so as to adjust/promote slidable engagement of the protrusions relative to the pathways. The method may include thereafter rotating gas cylinder housing 24 relative to second coupling member 120. The method may include providing the gas cylinder housing with handle 36. The method may include within the rotating step, rotating gas cylinder housing 24 relative to second coupling member 120 via the handle of the gas cylinder housing as seen by arrow 157 in FIG. 3.

As seen in FIGS. 3 and 5, the connecting step may include providing body 122 of the second coupling member with one or more bores 132 and 133 shaped to snugly receive pressure regulator mount 191. The method may include inhibiting fluid communication between gas cylinder 22 and gas delivery system 50 until protrusions 94 and 94′ reach inner or second ends 144 of pathways 136A as seen in FIG. 12B. Referring back to FIG. 5, the method may include configuring first pressure regulator 74 to be actuated to enable fluid communication between the gas cylinder and the gas delivery system only upon second end portion 191B of pressure regulator mount 191 being fully mated with and/or received within bore 133 of body 122 of second coupling member 120.

It will be appreciated that many variations are possible within the scope of the invention described herein. For example and as a further alternative, gas delivery system 50 seen in FIG. 1 may be said to comprise second pressure regulator 75 and tubing 77A and 77B coupled thereto, with quick locking assembly 70 thus being configured to selectively operatively connect and enable fluid communication between gas cylinder assembly 20 and the gas delivery system. As a further alternative, the quick locking assembly may be said to comprise part of the gas cylinder assembly.

Other types of quick locking assemblies or mechanism may be provided in other embodiments, such as push-to-connect or twist-to-lock mechanism. Some locking mechanisms may include safety features such as pressure relief valves or locking indicators to ensure that the connection is properly made and maintained.

Where a component (e.g. a member, apparatus, assembly, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure(s) which perform the function in the illustrated exemplary embodiments of the invention.

### INTERPRETATION OF TERMS

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

### ADDITIONAL DESCRIPTION

Examples of gas delivery systems and quick locking assemblies thereof, have been described. The following clauses are offered as further description.
(1) A quick locking assembly for a gas cylinder, the quick locking assembly comprising: a first coupling member having a primary bore shaped to receive in part a valve (and/or mount thereof) therewithin, the first coupling member including one or more protrusions extending radially-inwards within the primary bore thereof; and a second coupling member shaped to selectively fit within the primary bore of the first coupling member, the second coupling member including a first female portion shaped to couple with the valve (and/or mount thereof) and the second coupling member including one or more second female portions shaped to receive the one or more protrusions of the first coupling member therewithin, wherein each said second female portion is arcuate-shaped at least in part.
(2) A quick locking assembly according to any clause herein, wherein each said second female portion has an enlarged mouth shaped to receive a corresponding said protrusion therewithin.
(3) A quick locking assembly according to any clause herein, wherein each said second female portion has a first end shaped to receive a corresponding said protrusion therewithin, a second end spaced-apart from the first end, and an enlarged recessed portion extending from the first end thereof to the second end thereof.
(4) A quick locking assembly according to any clause herein, wherein the enlarged recessed portion tapers in a direction extending from the first end to the second end thereof.
(5) A quick locking assembly according to any clause herein, wherein the enlarged recessed portion is substantially triangular in side profile.
(6) A quick locking assembly according to any clause herein, wherein each said second female portion includes a first or axially-extending passage in fluid communication with the enlarged recessed portion.
(7) A quick locking assembly according to any clause herein, wherein the second coupling member is shaped to inhibit actuation of the valve until the first coupling member has rotated by a predetermined threshold relative to the second coupling member.
(8) A quick locking assembly according to any clause herein, wherein the predetermined threshold is at least 45 degrees.
(9) A quick locking assembly according to any clause herein, wherein the predetermined threshold is substantially 45 degrees.
(10) A quick locking assembly for a gas cylinder, the quick locking assembly comprising: a first coupling member having a primary bore; one or more protrusions coupled to the first coupling member and extending radially inwards into the primary bore at least in part; and a second coupling member having an exterior and one or more grooves extending along the exterior thereof, each said protrusion being shaped to extend at least in part within and move along a pathway defined by a respective said groove to enable mating of the second coupling member with the first coupling member, with the one or more protrusions so positioned within the one or more grooves being configured to inhibit decoupling the second coupling member from the first coupling member.
(11) A quick locking assembly of any clause herein, wherein the first coupling member has a proximal end and a distal end spaced-apart from the proximal end thereof, wherein the primary bore extends from the distal end towards the proximal end of the first coupling member and wherein the one or more protrusions are positioned adjacent the distal end of the first coupling member.
(12) A quick locking assembly of any clause herein, wherein one of the first and second coupling members is a male said coupling member at least in part and wherein the other of the first and second coupling members is a female said coupling member at least in part.
(13) A quick locking assembly of any clause herein, wherein the first coupling member is shaped to receive a valve (and/or a mount thereof) at least partially therewithin and wherein the second coupling member has a bore shaped to receive the valve (and/or said mount) at least in part, with the one or more protrusions being configured to be downstream of the bore when the first coupling member and the second coupling member are so coupled together.
(14) A quick locking assembly of any clause herein, wherein the one or more protrusions are shaped to frictionally engage with the grooves of the second coupling member at least in part.
(15) A quick locking assembly of any clause herein, wherein the one or more protrusions are shaped to slidably engage with the grooves of the second coupling member.
(16) A quick locking assembly of any clause herein, wherein the one or more protrusions are selectively adjustable.
(17) A quick locking assembly of any clause herein, wherein the one or more protrusions threadably couple to the first coupling member.
(18) A quick locking assembly of any clause herein, wherein the extent to which the one or more protrusions extend within the primary bore is selectively adjustable.
(19) A quick locking assembly of any clause herein, wherein positioning of the one or more protrusions is selectively adjustable via a drill bit engaging proximal end portions thereof.
(20) A quick locking assembly of any clause herein, wherein the one or more protrusions are locking plungers.
(21) A quick locking assembly of any clause herein, wherein the one or more protrusions are threadably coupled and adjustable relative to the first coupling member.
(22) A quick locking assembly for a gas cylinder, the quick locking assembly comprising: a first coupling member having a primary bore; a second coupling member shaped to be received at least in part within the primary bore of the first coupling member; and one or more protrusions coupled to the first coupling member and extending radially inwards at least in part into the primary bore of the first coupling member, the one or more protrusions being shaped to engage the second coupling member so received within the first coupling member and wherein the extent to which the one or more protrusions extend radially inwards is selectively adjustable.
(23) A quick locking assembly of any clause herein, wherein the second coupling member has one or more circumferentially spaced outer grooves along which respective said one or more protrusions are received in part when the first coupling member and the second coupling member are coupled together.
(24) A quick locking assembly of any clause herein, wherein the one or more protrusions are substantially enclosed by the first coupling member.
(25) A quick locking assembly for a gas cylinder, the quick locking assembly comprising: a first coupling member having a primary bore; a second coupling member shaped to be received at least in part within the primary bore of the first coupling member; and one or more protrusions coupled to the first coupling member and extending radially inwards at least in part into the primary bore of the first coupling member, the one or more protrusions being shaped to engage the second coupling member so received within the first coupling member and wherein the one or more protrusions are substantially enclosed by the first coupling member.
(26) A quick locking assembly of any clause herein, wherein for each said protrusion only a distal end portion thereof extends within the primary bore of the first coupling member.
(27) A quick locking assembly of any clause herein, wherein the one or more protrusions each include a proximal end portion, a distal end portion spaced-apart from the proximal end portion thereof, and an elongate portion between the end portions thereof and wherein the first coupling member has one or more auxiliary bores each shaped to receive and extend about the proximal end portion and the elongate portion of a respective said protrusion.
(28) A quick locking assembly of any clause herein, wherein for each said protrusion only the distal end portion thereof extends outwards from a corresponding said auxiliary bore of the first coupling member.
(29) A quick locking assembly of any clause herein, wherein the first coupling member has an outer diameter and wherein the primary bore has a diameter less than half of the outer diameter of the first coupling member.
(30) A quick locking assembly of any clause herein, wherein each said protrusion is radially inwardly spaced from an outer surface of the first coupling member.
(31) A quick locking assembly for a gas cylinder, the quick locking assembly comprising: a first coupling member having a primary bore; a second coupling member shaped to be received at least in part within the primary bore of the first coupling member; and one or more protrusions coupled to the first coupling member and extending radially inwards at least in part into the primary bore of the first coupling member, the one or more protrusions being shaped to engage the second coupling member so received within the first coupling member and wherein the one or more protrusions are radially inwardly spaced from an outer surface of the first coupling member.
(32) A quick locking assembly of any clause herein, wherein for each said protrusion the proximal end thereof is radially inwardly spaced from the outer surface of the first coupling member.
(33) A quick locking assembly of any clause herein, wherein the one or more protrusions align with a tapered portion of the first coupling member.
(34) A quick locking assembly of any clause herein, wherein the one or more protrusions align with an outwardly convex portion of the first coupling member.
(35) A quick locking assembly of any clause herein, wherein the one or more protrusions are adjacent to and spaced from the distal end of the first coupling member.
(36) A quick locking assembly of any clause herein, wherein the first coupling member has an interior beveled shoulder in fluid communication with the primary bore and wherein the second coupling member has an outer bevelled shoulder shaped to abut and/or extend adjacent to the inner beveled shoulder when the coupling members are fully coupled together.
(37) A quick locking assembly of any clause herein, wherein the second coupling member is substantially cylindrical in outer shape.
(38) A quick locking assembly of any clause herein, wherein the second coupling member comprises a body and a flange coupled to and extending radially outwards from the body thereof.
(39) A quick locking assembly of any clause herein, wherein the flange of the second coupling member is shaped to abut the distal end of the first coupling member when the first coupling member and the second coupling member are fully coupled together.
(40) A quick locking assembly of any clause herein, wherein the flange of the second coupling member is shaped to enclose the primary bore when the first coupling member and the second coupling member are fully coupled together.
(41) A quick locking assembly of any clause herein, wherein the flange of the second coupling member is shaped to inhibit access to the primary bore when the first coupling member and the second coupling member are fully coupled together.
(42) A quick locking assembly of any clause herein, wherein the second coupling member has an outer diameter and wherein each said protrusion has a length in the range of equal to or greater than one third of the outer diameter of the second coupling member and equal to or less than one half of the outer diameter of the second coupling member.
(43) A quick locking assembly of any clause herein, wherein the primary bore has a diameter and wherein each said protrusion has a length in the range of equal to or greater than one third of the diameter of the primary bore and equal to or less than one half of the diameter of the primary bore.
(44) A quick locking assembly of any clause herein, wherein each said protrusion is coupled to the first coupling member.
(45) A quick locking assembly of any clause herein, wherein the first coupling member has a longitudinal axis and wherein each said protrusion extends laterally and is axially fixed relative to the longitudinal axis of the first coupling member.
(46) A quick locking assembly of any clause herein, wherein each said protrusion is laterally adjustable relative to the longitudinal axis of the first coupling member.
(47) A quick locking assembly of any clause herein, wherein the first coupling member comprises said one or more protrusions.
(48) A quick locking assembly for a gas cylinder, the quick locking assembly comprising: a first male member that is longitudinally-extending and in fluid communication with the gas cylinder; one or more second male members each operatively connected to and extending perpendicular to the first male member; a first female member shaped to mate with the first male member; and one or more second female members shaped to receive the one or more second male members, wherein the one or more second female members are radially spaced from the first female member.
(49) A quick locking assembly of any clause herein, wherein the one or more second female members are arcuate-shaped at least in part.
(50) A quick locking assembly of any clause herein, wherein the first male member and one or more second male members are coupled together.
(51) A quick locking assembly of any clause herein, wherein the first female member and one or more second female members are coupled together.
(52) A quick locking assembly of any clause herein, wherein the first female member and one or more second female members are integrally connected together so as to form a unitary whole.
(53) A quick locking assembly for a gas cylinder, the quick locking assembly comprising: a first coupling member having a primary bore shaped to receive a valve (and/or a mount thereof) therewithin and including one or more protrusions extending radially-inwards within the primary bore thereof; and a second coupling member shaped to selectively fit within the primary bore of the first coupling member, the second coupling member including a first female portion shaped to couple with the valve (and/or the mount thereof) and the second coupling member including one or more second female portions, each said second female portion having an outwardly flared opening or enlarged recessed portion shaped to receive a respective said protrusion of the first coupling member at least partially therewithin.
(54) A quick locking assembly for a gas cylinder, the quick locking assembly comprising: a first coupling member having a primary bore shaped to receive a valve (and/or a mount thereof) therewithin and including one or more protrusions extending radially-inwards within the primary bore thereof; and a second coupling member shaped to selectively fit within the primary bore of the first coupling member, the second coupling member including a first female portion shaped to couple with the valve (and/or the mount thereof) and the second coupling member including one or more second female portions shaped to receive the one or more protrusions of the first coupling member at least partially therewithin, wherein each said second female portion is arcuate-shaped at least in part.
(55) A quick locking assembly according to any clause herein, wherein the one or more grooves are shaped to promote rotation of the first coupling member relative to the second coupling member when the coupling members are in the process of coupling together.
(56) A quick locking assembly according to any clause herein, including a housing shaped to receive the gas cylinder therewithin, and wherein the at least one or more protrusions couple to the housing.
(57) A quick locking assembly according to any clause herein, the housing includes a handle which facilitates rotation of the first coupling member relative to the second coupling member.
(58) A quick locking assembly according to any clause herein, wherein the handle is positioned adjacent a first end portion of the housing and wherein the one or more protrusions are positioned adjacent a second end portion of the housing.
(59) A quick locking assembly according to any clause herein, wherein the first coupling member comprises said valve (and/or the mount thereof).
(60) A quick locking assembly according to any clause herein, the valve comprises a pressure regulator.
(61) In combination, the first coupling member and said one or more protrusions of a quick locking assembly of any clause herein.
(62) The first coupling member of a quick locking assembly of any clause herein.
(63) The second coupling member of a quick locking assembly of any clause herein.
(64) A gas delivery system comprising a quick locking assembly of any clause herein.
(65) A female coupling member configured to couple to a pressure regulator of a gas cylinder, the female coupling member being substantially cylindrical in outer shape, the female coupling member having first and second ends, an outer surface extending between the ends thereof, and a bore extending from the first end towards the second end thereof, the bore of the female coupling member being shaped to receive therein a distal end portion of the pressure regulator (and/or a mount thereof), and the female coupling member having one or more pathways extending radially inwards from the outer surface thereof and from the first end towards the second end thereof, each said pathway having an enlarged recessed portion shaped to receive a corresponding locking member or plunger operatively coupled to the pressure regulator.
(66) A female coupling member configured to couple to a pressure regulator of a gas cylinder, the female coupling member being substantially cylindrical in outer shape, the female coupling member having first and second ends, an outer surface extending between the ends thereof and a bore extending from the first end towards the second end thereof, the bore of the female coupling member being shaped to receive therein a distal end portion of the pressure regulator (and/or a mount thereof), and the female coupling member having one or more pathways extending radially inwards from the outer surface thereof and from the first end towards the second end thereof, each said pathway being shaped to receive a corresponding locking member or plunger operatively coupled to the pressure regulator, and each said pathway being arcuate-shaped at least in part.
(67) An apparatus for selectively coupling a gas cylinder to a gas delivery system, the apparatus comprising: a male member including a valve with a first end portion thereof connectable to the gas cylinder; a female member connectable to the gas delivery system, the female member shaped to receive a second end portion of the valve (and/or a mount thereof), the female member including at least one pathway; and a housing shaped to receive the gas cylinder therewithin, the housing including at least one protrusion shaped to extend within and along the at least one pathway when the female member receives the male member to connect the gas cylinder to the gas delivery system.
(68) An apparatus according to any clause herein, wherein the at least one pathway is shaped to promote rotation of the male member relative to the female member when the female member is in the process of receiving the male member.
(69) An apparatus according to any clause herein, wherein the at least one pathway is shaped to receive a respective said protrusion (or distal end portion thereof) therethrough via a first end thereof.
(70) An apparatus according to any clause herein, wherein for each said pathway the first end thereof is outwardly flared.
(71) An apparatus according to any clause herein, wherein for each said pathway the second end thereof is shaped to inhibit a respective said protrusion from passing thereby.
(72) An apparatus according to any clause herein, wherein for each said pathway the first end thereof is enlarged and/or has an enlarged recessed portion adjacent thereto.
(73) An apparatus according to any clause herein wherein each said pathway has an arcuate shape at least in part.
(74) An apparatus according to any clause herein wherein each said pathway has a smooth contour.
(75) An apparatus according to any clause herein wherein each said pathway is configured to slidably engage with the distal end portion of a respective said protrusion.
(76) An apparatus according to any clause herein, including a seal positioned between the valve and the female member when the male member and the female member are mated together.
(77) An apparatus according to any clause herein, wherein the seal is an O-ring is fitted about the male member.
(78) An apparatus according to any clause herein wherein the housing includes a handle.
(79) An apparatus according to any clause herein, wherein the housing includes at least one holding plate.
(80) A gas cylinder assembly comprising: a housing having an interior shaped to receive a gas cylinder therewithin, the housing including a first end portion that is closed and a second end portion with a bore extending therethrough; a pressure regulator with a proximal end portion shaped to couple to an outlet of the gas cylinder and a distal end portion shaped to extend through and/or adjacent the bore of the second end portion of the housing; and a bonnet configured to operatively couple the distal end portion of the pressure regulator to the second end portion of the housing.
(81) A gas cylinder assembly comprising: a housing having an interior shaped to receive a gas cylinder therewithin, the housing including a first end portion that is closed and a second end portion with a bore extending therethrough; a pressure regulator with a proximal end portion shaped to couple to an outlet of the gas cylinder and a distal end portion; a female male adapter with a female portion thereof shaped to couple to the distal end portion of the pressure regulator, extend through said bore and abut an interior surface of the housing; and a female adapter shaped to couple to a male portion of the female male adapter and abut an exterior surface of the housing opposite the interior surface of the housing.
(82) A gas cylinder assembly according to any clause herein, wherein the female male adapter includes an exterior shoulder shaped to abut the interior surface of the housing and/or wherein the female adapter has a proximal or inner end shaped to abut the surface of the housing.
(83) A gas cylinder assembly comprising: a housing shaped to receive a gas cylinder therewithin between spaced-apart end portions thereof; a handle operatively connected to the first end portion of the housing; a pressure regulator connectable to the gas cylinder and positioned adjacent the second end portion of the housing; a longitudinally-extending first male member and one or more laterally-inwardly extending second male members operatively connected to the second end portion of the housing; and a gas delivery system shaped to mate with the male members so as to operatively connect to the gas cylinder via the pressure regulator upon the housing rotating a predetermined threshold of rotation relative thereto.
(84) A gas cylinder assembly according to any clause herein, wherein the gas delivery system including a female coupling member having one or more longitudinally-extending bores shaped to snugly and sealable receive the longitudinally-extending first male member and having one or more spiral pathways along an outer surface thereof, with the one or more spiral pathways shaped to slidably receive the one or more laterally-inwardly extending second male members.
(85) A gas cylinder assembly comprising: a pressure regulator including an inlet port, a diaphragm or piston in fluid communication with the inlet port, and a pressure-reducing mechanism, whereby high-pressure hydrogen gas is configured to enter through the inlet port of the pressure regulator and push against said diaphragm or piston, which triggers the pressure-reducing mechanism to control the flow of hydrogen gas and reduce the pressure thereof to a desired level, with the pressure regulator being configured to thereafter enable hydrogen gas of reduced pressure to exit from an outlet port thereof.
(86) A gas cylinder assembly according to any clause herein, wherein the pressure-reducing mechanism includes a spring extending about the piston.
(87) A gas cylinder assembly according to any clause herein, wherein the pressure regulator includes downstream and upstream sub-chambers, whereby pressure within the downstream sub-chamber causes force to be exerted in an upstream direction on the piston via a proximal end of the downstream sub-chamber and when said force exceeds the force of the spring biased towards the downstream direction, the piston moves in an upstream direction, causing the spring to compress, the upstream sub-chamber to reduce in size, and the downstream sub-chamber to expand, thereby lowering pressure in the downstream sub-chamber.
(88) A gas cylinder assembly according to any clause herein, wherein when the force exerted on the piston in the upstream direction by pressure inside the downstream sub-chamber is weaker than the force exerted in the downstream direction on the piston by the spring, the piston moves in the downstream direction, causing the spring to expand, the upstream sub-chamber to expand, and the downstream sub-chamber compresses thereby increasing pressure in the downstream chamber anew.
(89) A gas cylinder assembly according to any clause herein, including a plunger which selectively releases said hydrogen gas of reduced pressure.
(90) A gas cylinder assembly according to any clause herein, wherein the plunger has a length equal to or less than two inches.
(91) A gas cylinder assembly according to any clause herein, wherein the pressure regulator has a total length of equal to or less than 2.5 inches.
(92) A gas cylinder assembly according to any clause herein, wherein the pressure regulator is a first pressure regulator and including a second pressure regulator operatively connected to the first pressure regulator, with one or more said pressure regulators enabling variable output pressure control.
(93) A gas cylinder assembly according to any clause herein, wherein the first pressure regulator is configured to reduce pressure passing therethrough to 80 PSI.
(94) A gas cylinder assembly according to any clause herein, wherein the first pressure regulator is configured to reduce pressure passing therethrough from 4500 PSI to 80 PSI.
(95) A gas cylinder assembly according to any clause herein, wherein the second pressure regulator is configured to reduce pressure passing therethrough to 8 PSI.
(96) A gas cylinder assembly according to any clause herein, wherein the second pressure regulator is configured to reduce pressure passing therethrough from 80 PSI to 8 PSI.
(97) A gas cylinder assembly according to any clause herein, wherein the inlet and outlet ports of the pressure regulator are aligned along a longitudinal axis.
(98) A gas cylinder assembly according to any clause herein, wherein the first pressure regulator is configured to reduce pressure passing therethrough by a factor of 50 or more and/or wherein the second pressure regulator is configured to reduce pressure passing therethrough by a factor of 10 or more.
(99) A gas cylinder assembly for manually connecting a gas cylinder to a fuel cell, the gas cylinder assembly comprising: a housing including a first end portion, a second end portion with a bore extending therethrough, and a central portion extending between the end portions thereof, wherein at least one said end portion of the housing is selectively removable from the central portion of the housing to receive the gas cylinder therewithin; a handle operatively connected to the first end portion of the housing; a pressure regulator with a proximal end portion connectable to the gas cylinder and a distal end portion shaped to extend through the bore and operatively connect to the second end portion of the housing; one or more laterally-extending male members operatively connected to the second end portion of the housing and extending inwards in part within said bore; and a female coupling member shaped to rotatably engage with the one or more laterally-extending male members, with the female coupling member being fully received within the bore of the second end portion of the housing and enabling fluid communication via the pressure regulator between the gas cylinder to the fuel cell upon the housing rotating via the handle a predetermined threshold of rotation relative thereto.
(100) A gas cylinder assembly according to any clause herein, wherein the pressure regulator is configured to reduce pressure output therefrom by a factor sufficient to facilitate manual rotation via the handle of the one or more laterally-extending male members relative to the female coupling member.
(101) A gas cylinder assembly for manually connecting a gas cylinder to a fuel cell, the gas cylinder assembly comprising: a housing including a first end portion, a second end portion with a bore extending therethrough, and a central portion extending between the end portions thereof, wherein at least one said end portion of the housing is selectively removable from the central portion of the housing to receive the gas cylinder therewithin; a handle operatively connected to the first end portion of the housing; a pressure regulator with a proximal end portion connectable to the gas cylinder and a distal end portion shaped to extend through the bore and operatively connect to the second end portion of the housing; one or more laterally-extending male members operatively connected to the second end portion of the housing and extending inwards in part within said bore; and a female coupling member shaped to rotatably engage with the one or more laterally-extending male members to enable passage of the female coupling member with said bore, with the pressure regulator being actuated to enable fluid communication between the gas cylinder to the fuel cell only upon the female coupling member being fully received within said bore.
(102) A gas cylinder assembly for connecting a gas cylinder to a fuel cell, the gas cylinder assembly comprising: a first pressure regulator including an inlet port connectable to the gas cylinder and including an outlet port, the first pressure regulator being configured to reduce pressure passing therethrough by a first factor; a second pressure regulator including an inlet port and an outlet port connectable to the fuel cell, the second pressure regulator being configured to reduce pressure passing therethrough by a second factor which is less than the first factor; and a quick locking assembly via which the outlet port of the first pressure regulator and the inlet port of the second pressure regulator are selectively connectable.
(103) A gas cylinder assembly according to any clause herein, wherein the first factor is 5 or more times greater than the second factor.
(104) A gas cylinder assembly according to any clause herein, wherein the first factor is 50 or more and wherein the second factor is 10 or more.
(105) A connecting mechanism for coupling a pressure regulator of a gas cylinder to a gas delivery system, the connecting mechanism comprising: an annular flange extending about a bore and having an inner surface and exterior surface; a female male adapter with a female portion thereof shaped to couple to a distal end portion of the pressure regulator and abut the interior surface of the flange; and a female adapter operatively connectable to the gas delivery system, the female adapter being shaped to couple to a male portion of the female male adapter and abut the exterior surface of the flange.
(106) A method for selectively connecting a gas cylinder to a gas delivery system, the method comprising: connecting a male member to the gas cylinder; enclosing the gas cylinder within a housing, the housing including at least one protrusion in fluid communication with the male member; connecting a female member to the gas delivery system, the female member having at least one pathway extending about an exterior thereof, with the at least one pathway being spiral shaped at least in part; and connecting the male member and the female member together, including positioning the least one protrusion to be received at least in part within the at least one pathway and thereafter rotating the housing relative to the female member.
(107) A method according to any clause herein, including: providing the at least one pathway with an enlarged recessed portion to promote receiving the one or more protrusions therein when the male member is inserted into the female member.
(108) A method according to any clause herein, including: providing the at least one pathway with an arcuate shape at least in part.
(109) A method according to any clause herein, including: providing the at least one pathway with a smooth contour.
(110) A method according to any clause herein, including: shaping the at least one pathway to facilitate slidable engagement with the at least one protrusion (or distal end portion thereof).
(111) A method according to any clause herein, including: disposing a seal about one of the male member and the female member such that the seal is interposed between the members when the male member is fully inserted into the female member.
(112) A method according to any clause herein, including: providing the housing with a handle; and within the rotating step, rotating the housing relative to the female member via said handle.
(113) A method according to any clause herein, including: providing at least one holding plate shaped to stabilize the housing.
(114) A method according to any clause herein, including inhibiting fluid communication between the gas cylinder and the gas delivery system until the at least one protrusion reaches the inner or second end of the at least one pathway.
(115) A method according to any clause herein, including configuring the male member to only be actuated to enable fluid communication between the gas cylinder and the gas delivery system upon the male member being fully mated with the female member.
(116) Apparatus including any new and inventive feature, combination of features, or sub-combination of features as described herein.
(117) Methods including any new and inventive steps, acts, combination of steps and/or acts or sub-combination of steps and/or acts as described herein.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A gas cylinder assembly for manually connecting a gas cylinder to a fuel cell, the gas cylinder assembly comprising:
a housing including a first end portion, a second end portion with a bore extending therethrough, and a central portion extending between the end portions thereof, wherein at least one said end portion of the housing is selectively removable from the central portion of the housing to receive the gas cylinder therewithin;
a handle operatively connected to the first end portion of the housing;
a pressure regulator with a proximal end portion connectable to the gas cylinder and a distal end portion shaped to extend through the bore and operatively connect to the second end portion of the housing;
one or more laterally-extending male members operatively connected to the second end portion of the housing and extending inwards in part within said bore; and
a female coupling member shaped to rotatably engage with the one or more laterally-extending male members, with the female coupling member being fully received within the bore of the second end portion of the housing and enabling fluid communication via the pressure regulator between the gas cylinder to the fuel cell upon the housing rotating via the handle a predetermined threshold of rotation relative thereto.

2. A gas cylinder assembly according to claim 1, wherein the pressure regulator is configured to reduce pressure output therefrom by a factor sufficient to facilitate manual rotation via the handle of the one or more laterally-extending male members relative to the female coupling member.

3. A gas cylinder according to claim 1, wherein the gas cylinder includes a longitudinally-extending male member via which the pressure regulator couples to the second end portion of the housing, wherein the female coupling member has one or more longitudinally-extending bores shaped to snugly and sealable receive said longitudinally-extending male member, and wherein the female coupling member has one or more spiral pathways along an outer surface thereof, with the one or more spiral pathways being shaped to slidably receive the one or more laterally-extending male members.

4. A gas cylinder assembly according to claim 1, wherein the predetermined threshold of rotation is at least 45 degrees.

5. A gas cylinder assembly for manually connecting a gas cylinder to a fuel cell, the gas cylinder assembly comprising:
a housing including a first end portion, a second end portion with a bore extending therethrough, and a central portion extending between the end portions thereof, wherein at least one said end portion of the housing is selectively removable from the central portion of the housing to receive the gas cylinder therewithin;
a handle operatively connected to the first end portion of the housing;
a pressure regulator with a proximal end portion connectable to the gas cylinder and a distal end portion shaped to extend through the bore and operatively connect to the second end portion of the housing;
one or more laterally-extending male members operatively connected to the second end portion of the housing and extending inwards in part within said bore; and
a female coupling member shaped to rotatably engage with the one or more laterally-extending male members to enable passage of the female coupling member with said bore, with the pressure regulator being actuated to enable fluid communication between the gas cylinder to the fuel cell only upon the female coupling member being fully received within said bore.

6. A gas cylinder assembly for connecting a gas cylinder to a fuel cell, the gas cylinder assembly comprising:
a first pressure regulator including an inlet port connectable to the gas cylinder and including an outlet port, the first pressure regulator being configured to reduce pressure passing therethrough by a first factor;
a second pressure regulator including an inlet port and an outlet port connectable to the fuel cell, the second pressure regulator being configured to reduce pressure passing therethrough by a second factor which is less than the first factor; and
a quick locking assembly via which the outlet port of the first pressure regulator and the inlet port of the second pressure regulator are selectively connectable.

7. A gas cylinder assembly according to claim 6, wherein the first factor is 5 or more times greater than the second factor.

8. A gas cylinder assembly according to claim 6, wherein the first factor is 50 or more and wherein the second factor is 10 or more.

9. A gas cylinder assembly according to claim 6, wherein the quick locking assembly inhibits fluid communication between the first pressure regulator and the second pressure regulator until the quick locking assembly is fully mated with the first pressure regulator.

10. A gas cylinder assembly according to claim 6, wherein the quick locking assembly includes a female coupling member and one or more male members which rotatably couple thereto to a predetermined threshold of rotation to enable fluid communication between the pressure regulators and wherein said first factor of the first pressure regulator is selected to facilitate manual rotation of the one or more male members relative to the female coupling member.

11. A gas cylinder assembly according to claim 6, including a housing having an interior within which a gas cylinder is selectively receivable, wherein the quick locking assembly includes a longitudinally-extending first male member coupled to the first pressure regulator, one or more laterally-inwardly extending second male members operatively connected to the housing, and a female coupling member having one or more longitudinally-extending bores shaped to snugly and sealable receive the longitudinally-extending first male member, with the female coupling member having one or more spiral pathways along an outer surface thereof and with the one or more spiral pathways being shaped to slidably receive the one or more laterally-inwardly extending second male members.

12. A gas cylinder assembly according to claim 6, including a housing having an interior within which a gas cylinder is selectively receivable, wherein the housing includes or operatively connects to a first coupling member having a primary bore shaped to receive in part the pressure regulator therewithin, the first coupling member including one or more protrusions extending radially-inwards within the primary bore thereof, with the extent to which the one or more protrusions extend within the primary bore being selectively adjustable, wherein the gas cylinder assembly includes a second coupling member shaped to selectively fit within the primary bore of the first coupling member, the second coupling member including a first female portion shaped to couple with the pressure regulator and/or a mount thereof, and the second coupling member including one or more second female portions shaped to receive the one or more protrusions of the first coupling member therewithin.

13. A gas cylinder assembly according to claim 6, including a housing having an interior within which a gas cylinder is selectively receivable, wherein the housing includes or operatively connects to a first coupling member having a primary bore shaped to receive in part the pressure regulator therewithin, the first coupling member having one or more radially-extending bores in fluid communication with the primary bore thereof, the first coupling member including one or more protrusions each positioned in part with a corresponding said radially-extending bore and extending radially-inwards within the primary bore thereof, with each said protrusion having a length which is less than that of the corresponding said radially-extending bore, wherein the gas cylinder assembly includes a second coupling member shaped to selectively fit within the primary bore of the first coupling member, the second coupling member including a first female portion shaped to couple with the pressure regulator and/or a mount thereof, and the second coupling member including one or more second female portions shaped to receive the one or more protrusions of the first coupling member therewithin.

14. A gas cylinder assembly according to claim 12, wherein each said protrusion threadably couples to the housing.

15. A gas cylinder assembly according to claim 6, including a housing having an interior within which a gas cylinder is selectively receivable, wherein the housing includes or operatively connects to a first coupling member having a primary bore and one or more protrusions coupled to the first coupling member, with each said protrusion extending radially inwards at least in part into the primary bore of the first coupling member and being radially inwardly spaced from an outer surface of the first coupling member, and wherein the gas cylinder assembly includes a second coupling member shaped to be received at least in part within the primary bore of the first coupling member, with the one or more protrusions being shaped to engage the second coupling member so received within the first coupling member.

16. A gas cylinder assembly according to claim 6, including a housing having an interior within which a gas cylinder is selectively receivable, wherein the housing includes or operatively connects to a first coupling member having a primary bore and one or more protrusions coupled to the first coupling member, with each said protrusion extending radially inwards at least in part into the primary bore of the first coupling member, and wherein the gas cylinder assembly includes a second coupling member shaped to be received at least in part within the primary bore of the first coupling member, the second coupling member having one or more pathways along an outer surface thereof, each said pathway having a first end via which a respective said protrusion is received and having a second end spaced-apart from the first end thereof, with the quick locking assembly inhibiting fluid communication between the first and second pressure regulators until the one or more protrusions reach the second ends of the one or more pathways.

17. A gas cylinder assembly according to claim 6, including a housing having an interior within which a gas cylinder is selectively receivable, wherein the housing includes or operatively connects to a first coupling member having a primary bore and one or more protrusions coupled to the first coupling member, with each said protrusion extending radially inwards at least in part into the primary bore of the first coupling member, and wherein the gas cylinder assembly includes a second coupling member shaped to be received at least in part within the primary bore of the first coupling member, the second coupling member having one or more pathways along an outer surface thereof, each said pathway having a first end shaped to receive a corresponding said protrusion therewithin, having a second end spaced-apart from the first end, having an axially-extending passage extending from the first end to the second end thereof, and having an arcuate-shaped passage coupled to and in fluid communication with the axially-extending passage thereof.

18. A gas cylinder assembly according to claim 17, wherein each said arcuate-shaped passage is a continuous coil or spiral in shape.

19. A gas cylinder assembly according to claim 17, wherein each said arcuate-shaped passage extends circumferentially, laterally in part, and axially in part.

20. A gas cylinder assembly according to claim 6, wherein the first pressure regulator includes an inlet port, an outlet port, a piston positioned with an interior thereof between the inlet and outlet ports thereof, and a pressure-reducing mechanism, whereby the first pressure regulator is configured to receive high pressure gas via the inlet port thereof so as to push against the piston, which triggers the pressure-reducing mechanism to control the flow of the gas therethrough and reduce the pressure thereof to a desired level, with the pressure regulator being configured to thereafter enable the gas of reduced pressure to exit from said outlet port.
